(19) United States
(12) Patent Application Publication
(10) Pub. No.: US 2008/0295692 A1
(43) Pub. Date: Dec. 4, 2008

(54) UV CROSS-LINKED POLYMER FUNCTIONALIZED MOLECULAR SIEVE/POLYMER MIXED MATRIX MEMBRANES FOR SULFUR REDUCTION

(76) Inventors: Chunqing Liu, Schaumburg, IL (US); Jeffrey J. Chiou, Irvine, CA (US); Stephen T. Wilson, Libertyville, IL (US)

Correspondence Address: HONEYWELL INTELLECTUAL PROPERTY INC;PATENT SERVICES, 101 COLUMBIA DRIVE, P O BOX 2245 MAIL STOP AB/2B, MORRISTOWN, NJ, 07962, US

(21) Appl. No.: 11/757,030

(22) Filed: Jun. 1, 2007

(51) Int. Cl. B01D 46/00; B29C 71/04; C08K 3/30; C08K 3/32; C08K 3/34

(52) U.S. Cl. 95/285; 522/82; 522/83; 523/218

(57) ABSTRACT

The present invention discloses high performance UV cross-linked polymer functionalized molecular sieve/polymer mixed matrix membranes (MMMs), the method of making these membranes, and the use of such membranes for separations. These UV cross-linked MMMs were prepared by incorporating polyethersulfone functionalized molecular sieves such as AlPO-14 and UZM-25 into a continuous UV cross-linkable polymer matrix followed by UV cross-linking. The UV cross-linked MMMs in the form of symmetric dense film, asymmetric flat sheet membrane, or asymmetric hollow fiber membranes described in the current invention have good flexibility and high mechanical strength, and exhibit significantly enhanced selectivity and permeability over the polymer membranes made from the corresponding continuous polyimide polymer matrices for carbon dioxide/methane (CO₂/CH₄) and hydrogen/methane (H₂/CH₄) separations. The MMMs of the present invention are suitable for a variety of liquid, gas, and vapor separations such as deep desulfurization of gasoline and diesel fuels.

### FIELD OF THE INVENTION

This invention relates to a process of reducing sulfur content in a hydrocarbon stream. More specifically, the present invention relates to a membrane separation process for reducing the sulfur content of a naphtha feed stream, in particular, a FCC naphtha, while substantially maintaining the initial olefin content of the feed.

### BACKGROUND OF THE INVENTION

Environmental concerns have resulted in legislation which places limits on the sulfur content of gasoline. In the European Union, for instance, a maximum sulfur level of 150 ppm by the year 2000 was stipulated, with a further reduction to a maximum of 50 ppm by the year 2005. Sulfur in the gasoline is a direct contributor of SOx emissions, and it also poisons the low temperature activity of automotive catalytic converters. When considering the effects of changes in fuel composition on emissions, lowering the level of sulfur has the largest potential for combined reduction in hydrocarbon, CO and NOx emissions.

Gasoline comprises a mixture of products from several process units, but the major source of sulfur in the gasoline pool is fluid catalytic cracking (FCC) naphtha which usually contributes between a third and a half of the total amount of the gasoline pool. Thus, effective sulfur reduction is most efficient when focusing attention on FCC naphtha.

A number of solutions have been suggested to reduce sulfur in gasoline, but none of them have proven to be ideal. Since sulfur in the FCC feed is the prime contributor of sulfur level in FCC naphtha, one known approach is hydrotreating the feed. While hydrotreating allows the sulfur content in gasoline to be reduced to any desired level, installing or adding the necessary hydrotreating capacity requires a substantial capital expenditure and increased operating costs. Further, olefin and naphthene compounds are susceptible to hydrogenation during hydrotreating. This leads to a significant loss in octane number. Hydrotreating the FCC naphtha is also problematic since the high olefin content is again prone to hydrogenation.

It would be highly desirable to use a selective membrane separation technique for the reduction of sulfur in hydrocarbon streams, in particular, naphtha streams. Membrane processing offers a number of potential advantages over conventional sulfur removal processes, including greater selectivity, lower operating costs, easily scaled operations, adaptability to changes in process streams and simple control schemes.

This invention pertains to high performance UV cross-linked polymer functionalized molecular sieve/polymer mixed matrix membranes (MMMs) with either no macrovoids or voids of less than several angstroms at the interface of the polymer matrix and the molecular sieves. In addition, the invention pertains to the method of making and methods of using such UV cross-linked MMMs.

Gas separation processes using membranes have undergone a major evolution since the introduction of the first membrane-based industrial hydrogen separation process about two decades ago. The design of new materials and efficient methods will continue to further advance membrane gas separation processes.

The gas transport properties of many glassy and rubbery polymers have been measured as part of the search for materials with high permeability and high selectivity for potential use as gas separation membranes. Unfortunately, an important limitation in the development of new membranes for gas separation applications is a well-known trade-off between permeability and selectivity of polymers. By comparing the data of hundreds of different polymers, Robeson demonstrated that selectivity and permeability of polymer membranes seem to be inseparably linked to one another, in a relation where selectivity increases as permeability decreases and vice versa.

Despite concentrated efforts to tailor polymer structure to improve separation properties, current polymeric membrane materials have seemingly reached a limit in the trade-off between productivity and selectivity. For example, many polyimide and polyetherimide glassy polymers such as Ultem® 1000 have significantly higher intrinsic CO₂/CH₄ selectivities (α_{CO2/CH4}) (about 30 at 50° C. and 690 kPa (100 psig) pure gas tests) than that of cellulose acetate (about 22), which are more attractive for practical gas separation applications. However, these polyimide and polyetherimide polymers, do not have outstanding permeabilities attractive for commercialization compared to current commercial cellulose acetate membrane products, in agreement with the trade-off relationship reported by Robeson. There also exist some inorganic membranes such as Si-DDR zeolite and carbon molecular sieve membranes that offer much higher permeability and selectivity than polymeric membranes for separations, but these membranes have been found to be too expensive and difficult for large-scale manufacture. Therefore, it is highly desirable to provide an alternate cost-effective membrane with improved separation properties and if possible, possessing separation properties above the trade-off curves between permeability and selectivity.

Based on the need for a more efficient membrane than polymer and inorganic membranes, a new type of membrane, mixed matrix membranes (MMMs), has been developed in recent years. MMMs are hybrid membranes containing inorganic fillers such as molecular sieves dispersed in a polymer matrix.

Mixed matrix membranes have the potential to achieve higher selectivity with equal or greater permeability compared to existing polymer membranes, while maintaining their advantages such as low cost and easy processability. Much of the research conducted to date on mixed matrix membranes has focused on the combination of a dispersed solid molecular sieving phase, such as zeolitic molecular sieves or carbon molecular sieves, with an easily processed continuous polymer matrix. For example, see U.S. Pat. No. 4,705,540; U.S. Pat. No. 4,717,393; U.S. Pat. No. 4,740,219; U.S. Pat. No. 4,880,442; U.S. Pat. No. 4,925,459; U.S. Pat. No. 4,925,562; U.S. Pat. No. 5,085,676; U.S. Pat. No. 5,127,925; U.S. Pat. No. 6,500,233; U.S. Pat. No. 6,503,295; U.S. Pat. No. 6,508,860; U.S. Pat. No. 6,562,110; U.S. Pat. No. 6,626,980; U.S. Pat. No. 6,663,805; U.S. Pat. No. 6,755,900; U.S. Pat. No. 7,018,445; U.S. Pat. No. 7,109,140; U.S. Pat. No. 7,166,146; US 2004/0147796; US 2005/0043167; US 2005/0230305; US 2005/0268782; US 2006/0107830; and US 2006/0117949. For example, The sieving phase in a solid/polymer mixed matrix scenario can have a selectivity that is significantly larger than the pure polymer. Therefore, in theory the addition of a small volume fraction of molecular sieves to the polymer matrix will increase the overall separation efficiency significantly. Typical inorganic sieving phases in MMMs include various molecular sieves, carbon molecular sieves, and silica. Many organic polymers, including cellulose acetate, polyvinyl acetate, polyetherimide (commercially Ultem®), polysulfone (commercial Udel®), polydimethylsiloxane, polyethersulfone, and polyimides (including commercial Matrimid®), have been used as the continuous phase in MMMs.

While the polymer “upper-bound” curve has been surpassed using solid/polymer MMMs, there are still many issues that need to be addressed for large-scale industrial production of these new types of MMMs. For example, for most of the molecular sieve/polymer MMMs reported in the literature, voids and defects at the interface of the inorganic molecular sieves and the organic polymer matrix were observed due to the poor interfacial adhesion and poor materials compatibility. These voids, that are much larger than the penetrating molecules, resulted in reduced overall selectivity of the MMMs. Research has shown that the interfacial region, which is a transition phase between the continuous polymer and dispersed sieve phases, is of particular importance in forming successful MMMs.

Most recently, significant research efforts have been focused on materials compatibility and adhesion at the inorganic molecular sieve/polymer interface of the MMMs in order to achieve separation property enhancements over traditional polymers. For example, Kulkarni et al. and Marand et al. reported the use of organosilicon coupling agent functionalized molecular sieves to improve the adhesion at the sieve particle/polymer interface of the MMMs. See U.S. Pat. No. 6,508,860 and U.S. Pat. No. 7,109,140 B2. Kulkarni et al. also reported the formation of MMMs with minimal macrovoids and defects by using electrostatically stabilized suspensions. See US 2006/0117949.

Despite all the research efforts, issues of material compatibility and adhesion at the inorganic molecular sieve/polymer interface of the MMMs are still not completely addressed.

A previous patent application entitled “Cross-linkable and cross-linked Mixed Matrix Membranes and Methods of Making the Same” U.S. application Ser. No. 11/300,775, was filed Dec. 15, 2005 (incorporated herein in its entirety). In that earlier application, a new type of UV cross-linkable and UV cross-linked molecular sieve/polymer mixed matrix membranes (MMMs) using porous molecular sieves as the dispersed fillers and a polymer as the continuous polymer matrix was disclosed for the first time. The present invention is an improvement on that earlier application. It has now been discovered that high selectivity UV cross-linked MMMs with either no macrovoids or voids of less than several angstroms at the interface of the polymer matrix and the molecular sieves can be successfully prepared by incorporating polymer functionalized molecular sieves such as AlPO-14 or UZM-25 into a continuous polyimide polymer matrix followed by UV cross-linking. Polyethersulfone (PES) was found to be a particularly useful polymer to provide the polymer functionalized molecular sieves. Accordingly, a method for large-scale membrane manufacturing is disclosed for the fabrication of void-free and defect-free UV cross-linked polymer functionalized molecular sieve/polymer MMMs.

### SUMMARY OF THE INVENTION

This invention pertains to novel void-free and defect-free UV cross-linked polymer functionalized molecular sieve/polymer mixed matrix membranes (MMMs). More particularly, the invention pertains to a novel method of making these UV cross-linked polymer functionalized molecular sieve/polymer MMMs. Most particularly, the invention relates to a membrane separation process for reducing the sulfur content of a naphtha feed stream, in particular, a FCC naphtha, while substantially maintaining the initial olefin content of the feed.

The present invention relates to UV cross-linked polymer functionalized molecular sieve/polymer mixed matrix membranes (MMMs) with either no macrovoids or at most voids of less than 5 angstroms (0.5 nm) at the interface of the polymer matrix and the molecular sieves by UV cross-linking UV cross-linkable polymer functionalized molecular sieve/polymer MMMs containing polymer (e.g., polyethersulfone) functionalized molecular sieves as the dispersed fillers and a continuous UV cross-linkable polymer (e.g., polyimide) matrix. The UV cross-linked MMMs in the forms of symmetric dense film, asymmetric flat sheet membrane, or asymmetric hollow fiber membranes fabricated by the method described herein have good flexibility and high mechanical strength, and exhibit significantly enhanced selectivity and permeability over the polymer membranes made from the corresponding continuous polyimide polymer matrices for carbon dioxide/methane (CO₂/CH₄) and hydrogen/methane (H₂/CH₄) separations. The UV cross-linked MMMs of the present invention are also suitable for a variety of liquid, gas, and vapor separations such as deep desulfurization of gasoline and diesel fuels, ethanol/water separations, pervaporation dehydration of aqueous/organic mixtures, CO₂/CH₄, CO₂/N₂, H₂/CH₄, O₂/N₂, olefin/paraffin, iso/normal paraffins separations, and other light gas mixture separations.

The present invention provides a method of making void-free and defect-free UV cross-linked polymer functionalized molecular sieve/polymer MMMs using stable polymer functionalized molecular sieve/polymer suspensions (or so-called “casting dope”) containing dispersed polymer functionalized molecular sieve particles and a dissolved continuous UV cross-linkable polymer matrix in a mixture of organic solvents. The method of making the membranes comprises: (a) dispersing the molecular sieve particles in a mixture of two or more organic solvents by ultrasonic mixing and/or mechanical stirring or other method to form a molecular sieve slurry; (b) dissolving a suitable polymer in the molecular sieve slurry to functionalize the surface of the molecular sieve particles; (c) dissolving a UV cross-linkable polymer that serves as a continuous polymer matrix in the polymer functionalized molecular sieve slurry to form a stable polymer functionalized molecular sieve/polymer suspension; (d) fabricating a MMM in a form of symmetric dense film (FIG. 1), asymmetric flat sheet (FIG. 2), thin-film composite (TFC, FIG. 3), or asymmetric hollow fiber using the polymer functionalized molecular sieve/polymer suspension; (e) cross-linking the MMM under UV radiation.

In some cases a membrane post-treatment step can be added to improve selectivity provided that the step does not significantly change or damage the membrane, or cause the membrane to lose performance with time (FIG. 4). This membrane post-treatment step can involve coating the top surface of the MMM with a thin layer of UV radiation curable epoxy silicon material and then UV cross-linking the surface coated MMM under UV radiation. The membrane post-treatment step can also involve coating the top surface of the UV cross-linked MMM with a thin layer of material such as a polysiloxane, a fluoro-polymer, or a thermally curable silicon rubber.

The molecular sieves in the MMMs provided in this invention can have selectivity and/or permeability that are significantly higher than the UV cross-linkable polymer matrix. Addition of a small weight percent of molecular sieves to the UV cross-linkable polymer matrix, therefore, increases the overall separation efficiency. The UV cross-linking can further improve the overall separation efficiency of the UV cross-linkable MMMs. The molecular sieves used in the UV cross-linked MMMs of the current invention include microporous and mesoporous molecular sieves, carbon molecular sieves, and porous metal-organic frameworks (MOFs). The microporous molecular sieves are selected from, but are not limited to, small pore microporous alumino-phosphate molecular sieves such as AlPO-18 (3.8×3.8 Å), AlPO-14 (1.9×4.6 Å, 2.1×4.9 Å, and 3.3×4.0 Å), AlPO-52 (3.2×3.8 Å, 3.6×3.8 Å), and AlPO-17 (5.1×3.6 Å), small pore microporous aluminosilicate molecular sieves such as UZM-5 (3.2×3.2 Å, 3.6×4.4 Å), UZM-25 (2.5×4.2 Å, 3.1×4.7 Å), and UZM-9 (3.8×3.8 Å), small pore microporous silico-alumino-phosphate molecular sieves such as SAPO-34 (3.8×3.8 Å), SAPO-56 (3.4×3.6 Å), and mixtures thereof.

More importantly, the molecular sieve particles dispersed in the concentrated suspension are functionalized by a suitable polymer such as polyethersulfone (PES), which results in the formation of either polymer-O-molecular sieve covalent bonds via reactions between the hydroxyl (—OH) groups on the surfaces of the molecular sieves and the hydroxyl (—OH) groups at the polymer chain ends or at the polymer side chains of the molecular sieve stabilizers such as PES or hydrogen bonds between the hydroxyl groups on the surfaces of the molecular sieves and the functional groups such as ether groups on the polymer chains. The functionalization of the surfaces of the molecular sieves using a suitable polymer provides good compatibility and an interface substantially free of voids and defects at the molecular sieve/polymer used to functionalize molecular sieves/polymer matrix interface. Therefore, voids and defects free UV cross-linkable polymer functionalized molecular sieve/polymer MMMs with significant separation property enhancements over traditional polymer membranes and over those prepared from suspensions containing the same polymer matrix and same molecular sieves but without polymer functionalization have been successfully prepared using these stable polymer functionalized molecular sieve/polymer suspensions. UV cross-linking of these MMMs further improve the overall separation efficiency. An absence of voids and defects at the interface increases the likelihood that the permeating species will be separated by passing through the pores of the molecular sieves in MMMs rather than passing unseparated through voids and defects in the membrane. The UV cross-linked MMMs fabricated using the present invention combine the solution-diffusion mechanism of polymer membrane and the molecular sieving and sorption mechanism of molecular sieves (FIG. 5), and assure maximum selectivity and consistent performance among different membrane samples comprising the same molecular sieve/polymer composition. The functions of the polymer used to functionalize the molecular sieve particles in the UV cross-linked MMMs of the present invention include: 1) forming good adhesion at the molecular sieve/polymer used to functionalize molecular sieves interface via hydrogen bonds or molecular sieve-O-polymer covalent bonds; 2) being an intermediate to improve the compatibility of the molecular sieves with the continuous polymer matrix; 3) stabilizing the molecular sieve particles in the concentrated suspensions to remain homogeneously suspended.

The stabilized suspension contains polymer functionalized molecular sieve particles are uniformly dispersed in a continuous UV cross-linkable polymer matrix. The UV cross-linked MMM, particularly symmetric dense film MMM, asymmetric flat sheet MMM, or asymmetric hollow fiber MMM, are fabricated from the stabilized suspension. A UV cross-linked MMM prepared by the present invention comprises uniformly dispersed polymer functionalized molecular sieve particles throughout the continuous UV cross-linked polymer matrix. The continuous UV cross-linked polymer matrix is formed by UV cross-linking a UV cross-linkable glassy polymer such as a UV cross-linkable polyimide under UV radiation. The polymer used to functionalize the molecular sieve particles is selected from a polymer different from the UV cross-linked polymer matrix.

The method of the current invention is suitable for large scale membrane production and can be integrated into commercial polymer membrane manufacturing processes.

The invention further provides a process for separating at least one gas from a mixture of gases using the UV cross-linked MMMs described herein, such process comprising (a) providing a UV cross-linked MMM comprising a polymer functionalized molecular sieve filler material uniformly dispersed in a continuous UV cross-linked polymer matrix which is permeable to said at least one gas; (b) contacting the mixture on one side of the UV cross-linked MMM to cause said at least one gas to permeate the UV cross-linked MMM; and (c) removing from the opposite side of the membrane a permeate gas composition comprising a portion of said at least one gas which permeated said membrane.

The UV cross-linked MMMs of the present invention are suitable for a variety of liquid, gas, and vapor separations such as deep desulfurization of gasoline and diesel fuels, ethanol/water separations, pervaporation dehydration of aqueous/organic mixtures, CO₂/CH₄, CO₂/N₂, H₂/CH₄, O₂/N₂, olefin/paraffin, iso/normal paraffins separations, and other light gas mixture separations.

We have now developed a selective membrane separation process which preferentially reduces the sulfur content of a hydrocarbon containing naphtha feed while substantially maintaining the content of olefins presence in the feed. The term “substantially maintaining the content of olefins presence in the feed” is used herein to indicate maintaining at least 50 wt-% of olefins initially present in the untreated feed. In accordance with the process of the invention, the naphtha feed stream is contacted with a membrane separation zone containing a membrane having a sufficient flux and selectivity to separate a permeate fraction enriched in aromatic and nonaromatic hydrocarbon containing sulfur species and a sulfur deficient retentate fraction. The retentate fraction produced by the membrane process can be employed directly or blended into a gasoline pool without further processing. The sulfur enriched fraction is treated to reduce sulfur content using conventional sulfur removal technologies, e.g. hydrotreating. The sulfur reduced permeate product may thereafter be blended into a gasoline pool.

In accordance with the process of the invention, the sulfur deficient retentate comprises no less than 50 wt-% of the feed and retains greater than 50 wt-% of the initial olefin content of the feed. Consequently, the process of the invention offers the advantage of improved economics by minimizing the volume of the feed to be treated by conventional high cost sulfur reduction technologies, e.g. hydrotreating. Additionally, the process of the invention provides for an increase in the olefin content of the overall naphtha product without the need for additional processing to restore octane values.

The membrane process of the invention offers further advantages over conventional sulfur removal processes such as lower capital and operating expenses, greater selectivity, easily scaled operations, and greater adaptability to changes in process streams and simple control schemes.

The invention can be better understood with reference to the following drawings and accompanying description.

### BRIEF DESCRIPTION OF THE DRAWINGS

FIG. 1 is a schematic drawing of a symmetric UV cross-linked mixed matrix dense film containing dispersed polymer coated molecular sieves and a continuous UV cross-linked polymer matrix.

FIG. 2 is a schematic drawing of an asymmetric UV cross-linked mixed matrix membrane containing dispersed polymer coated molecular sieves and a continuous UV cross-linked polymer matrix fabricated on a porous support substrate.

FIG. 3 is a schematic drawing of an asymmetric thin-film composite UV cross-linked mixed matrix membrane containing dispersed polymer coated molecular sieves and a continuous UV cross-linked polymer matrix fabricated on a porous support substrate.

FIG. 4 is a schematic drawing of a post-treated asymmetric UV cross-linked mixed matrix membrane containing dispersed polymer coated molecular sieves and a continuous UV cross-linked polymer matrix fabricated on a porous support substrate and coated with a thin polymer layer.

FIG. 5 is a schematic drawing illustrating the separation mechanism of UV cross-linked polymer coated molecular sieve/polymer mixed matrix membranes combining solution-diffusion mechanism of UV cross-linked polymer membranes and molecular sieving mechanism of molecular sieve membranes.

FIG. 6 is a schematic drawing showing the formation of polymer functionalized molecular sieve via covalent bonds.

FIG. 7 is a chemical structure drawing of poly(BTDA-PMDA-ODPA-TMMDA).

FIG. 8 is a chemical structure drawing of poly(DSDA-TMMDA).

FIG. 9 is a chemical structure drawing of poly(DSDA-PMDA-TMMDA).

FIG. 10a is the structures and preparation of UV-cross-linkable microporous polymers showing the reaction and the hydroxyl group containing monomers “A1 to A12”.

FIG. 10b is the structure of “B1 to B10” to be used in the reaction shown in FIG. 10a.

FIG. 11 is a plot showing CO₂/CH₄ separation performance of P1, Control 1, MMM 1 and MMM 2 membranes.

FIG. 12 is a plot showing H₂/CH₄ separation performance of P1, Control 1, and MMM 1 membranes.

FIG. 13 is a plot showing CO₂/CH₄ separation performance of P2 and MMM 3 membranes.

FIG. 14 is a plot showing CO₂/CH₄ separation performance of P3, Control 2, and MMM 5 membranes.

### DETAILED DESCRIPTION OF THE INVENTION

Mixed matrix membrane (MMM) containing dispersed molecular sieve fillers in a continuous polymer matrix may retain polymer processability and improve selectivity for separations due to the superior molecular sieving and sorption properties of the molecular sieve materials. The MMMs have received worldwide attention during the last two decades. For most types of MMMs, however, aggregation of the molecular sieve particles in the polymer matrix and poor adhesion at the interface of molecular sieve particles and the polymer matrix in MMMs that result in poor mechanical and processing properties and poor permeation performance still need to be addressed. Material compatibility and good adhesion between the polymer matrix and the molecular sieve particles are needed to achieve enhanced selectivity of the MMMs. Poor adhesion that results in voids and defects around the molecular sieve particles that are larger than the pores inside the molecular sieves decrease the overall selectivity of the MMM by allowing the species to be separated to bypass the pores of the molecular sieves. Thus, the MMMs can only at most exhibit the selectivity of the continuous polymer matrix.

The present invention pertains to novel void-free and defect-free UV cross-linked polymer functionalized molecular sieve/polymer mixed matrix membranes (MMMs). More particularly, the invention pertains to a novel method of making and methods of using these UV cross-linked polymer functionalized molecular sieve/polymer MMMs. Most particularly, the invention relates to a membrane separation process for reducing the sulfur content of a naphtha feed stream, in particular, a FCC naphtha, while substantially maintaining the initial olefin content of the feed. The UV cross-linked MMMs are prepared by UV cross-linking the polymer functionalized molecular sieve/polymer MMMs made from stabilized concentrated suspensions (also called “casting dope”) containing uniformly dispersed polymer functionalized molecular sieves and a continuous UV cross-linkable polymer matrix. The term “mixed matrix” as used in this invention means that the membrane has a selective permeable layer which comprises a continuous UV cross-linkable polymer matrix and discrete polymer functionalized molecular sieve particles uniformly dispersed throughout the continuous UV cross-linkable polymer matrix. The term “UV cross-linkable polymer matrix” as used herein means that all the polymer matrices used in the current invention contain UV sensitive functional groups that can connect with each other to form an interpolymer-chain-connected cross-linked polymer structure when exposed to UV radiation. The term “UV cross-linked” as used in this invention means that an interpolymer-chain-connected cross-linked polymer structure was formed under UV radiation.

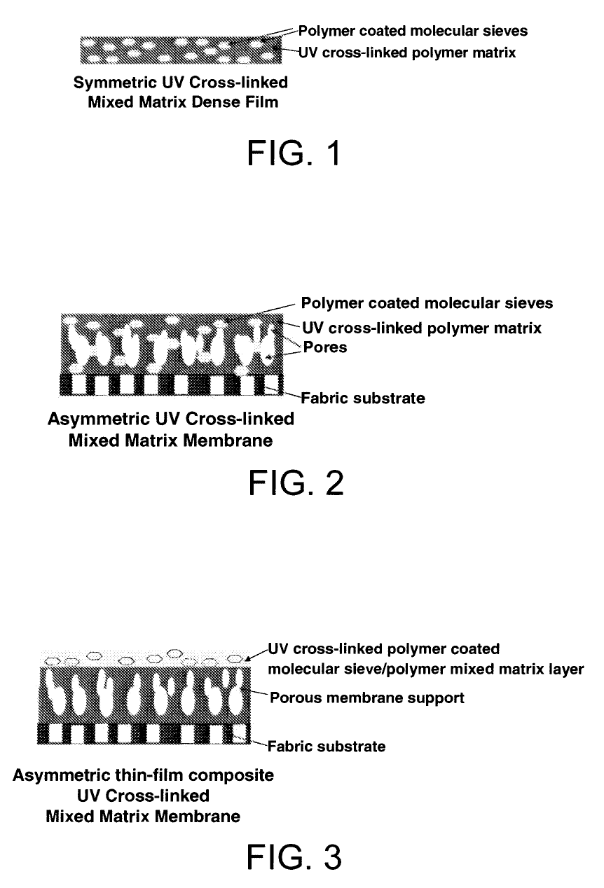

The present invention provides a novel method of making UV cross-linked mixed matrix membranes (MMMs), particularly dense film UV cross-linked MMMs, asymmetric flat sheet UV cross-linked MMMs, asymmetric thin-film composite MMMs, or asymmetric hollow fiber UV cross-linked MMMs, using stabilized concentrated suspensions containing dispersed polymer functionalized molecular sieve particles and a dissolved continuous polymer matrix in a mixture of organic solvents. The method comprises: (a) dispersing the molecular sieve particles in a mixture of two or more organic solvents by ultrasonic mixing and/or mechanical stirring or other method to form a molecular sieve slurry; (b) dissolving a suitable polymer in the molecular sieve slurry to functionalize the surface of the molecular sieve particles; (c) dissolving a UV cross-linkable polymer that serves as a continuous polymer matrix in the polymer functionalized molecular sieve slurry to form a stable polymer functionalized molecular sieve/polymer suspension; (d) fabricating a MMM in a form of symmetric dense film (FIG. 1), asymmetric flat sheet (FIG. 2), asymmetric thin-film composite (FIG. 3), or asymmetric hollow fiber using the polymer functionalized molecular sieve/polymer suspension; and e) cross-linking the MMM under UV radiation to form a UV cross-linked MMM.

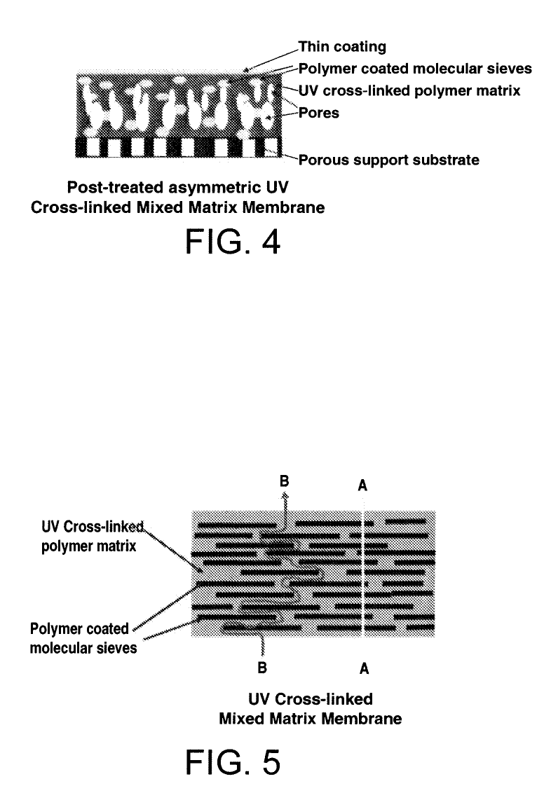

In some cases, a membrane post-treatment step can be added to improve selectivity but does not change or damage the membrane, or cause the membrane to lose performance with time (FIG. 4). The membrane post-treatment step can involve coating the top surface of the UV cross-linkable MMM with a thin layer of UV radiation curable epoxy silicon material and then UV cross-linking the surface coated UV cross-linkable MMM under UV radiation. The membrane post-treatment step can also involve coating the top surface of the UV cross-linked MMM with a thin layer of material such as a polysiloxane, a fluoro-polymer, or a thermally curable silicon rubber.

Design of the UV cross-linked MMMs containing uniformly dispersed polymer functionalized molecular sieves described herein is based on the proper selection of molecular sieves, the polymer used to functionalize the molecular sieves, the UV cross-linkable polymer served as the continuous polymer matrix, and the solvents used to dissolve the polymers.

The molecular sieves in the UV cross-linked MMMs provided in this invention can have a selectivity that is significantly higher than the polymer matrix for separations. Addition of a small weight percent of molecular sieves to the polymer matrix, therefore, increases the overall separation efficiency. The UV cross-linking can further significantly improve the overall separation efficiency of the UV cross-linkable MMMs. The molecular sieves used in the UV cross-linked MMMs of current invention include microporous and mesoporous molecular sieves, carbon molecular sieves, and porous metal-organic frameworks (MOFs).

Molecular sieves improve the performance of the polymer matrix by including selective holes/pores with a size that permits a gas such as carbon dioxide to pass through, but either does not permit another gas such as methane to pass through, or permits it to pass through at a significantly slower rate. The molecular sieves should have higher selectivity for the desired separations than the original polymer to enhance the performance of the MMM. In order to obtain the desired gas separation in the UV cross-linked MMM, it is preferred that the steady-state permeability of the faster permeating gas component in the molecular sieves be at least equal to that of the faster permeating gas in the original polymer matrix phase. Molecular sieves have framework structures which may be characterized by distinctive wide-angle X-ray diffraction patterns. Zeolites are a subclass of molecular sieves based on an aluminosilicate composition. Non-zeolitic molecular sieves are based on other compositions such as aluminophosphates, silico-aluminophosphates, and silica. Molecular sieves of different chemical compositions can have the same framework structure.

Zeolites can be further broadly described as molecular sieves in which complex aluminosilicate molecules assemble to define a three-dimensional framework structure enclosing cavities occupied by ions and water molecules which can move with significant freedom within the zeolite matrix. In commercially useful zeolites, the water molecules can be removed or replaced without destroying the framework structure. Zeolite composition can be represented by the following formula: M_{2/n}O:Al₂O₃:xSiO₂:yH₂O, wherein M is a cation of valence n, x is greater than or equal to 2, and y is a number determined by the porosity and the hydration state of the zeolites, generally from 0 to 8. In naturally occurring zeolites, M is principally represented by Na, Ca, K, Mg and Ba in proportions usually reflecting their approximate geochemical abundance. The cations M are loosely bound to the structure and can frequently be completely or partially replaced with other cations or hydrogen by conventional ion exchange. Acid forms of molecular sieve sorbents can be prepared by a variety of techniques including ammonium exchange followed by calcination or by direct exchange of alkali ions for protons using mineral acids or ion exchangers.

Microporous molecular sieve materials are microporous crystals with pores of a well-defined size ranging from about 0.2 to 2 nm. This discrete porosity provides molecular sieving properties to these materials which have found wide applications as catalysts and sorption media. Molecular sieve structure types can be identified by their structure type code as assigned by the IZA Structure Commission following the rules set up by the IUPAC Commission on Zeolite Nomenclature. Each unique framework topology is designated by a structure type code consisting of three capital letters. Preferred molecular sieves used in the present invention include molecular sieves having IZA structural designations of AEI, CHA, ERI, LEV, AFX, AFT and GIS. Exemplary compositions of such small pore alumina containing molecular sieves include non-zeolitic molecular sieves (NZMS) comprising certain aluminophosphates (AlPO's), silicoaluminophosphates (SAPO's), metalloaluminophosphates (MeAPO's), elemental aluminophosphates (ElAPO's), metallo-silicoaluminophosphates (MeAPSO's) and elemental silicoaluminophosphates (ElAPSO's). Preferably, the microporous molecular sieves used for the preparation of the UV cross-linked MMMs in the current invention are small pore molecular sieves such as SAPO-34, Si-DDR, UZM-9, AlPO-14, AlPO-34, AlPO-17, SSZ-62, SSZ-13, AlPO-18, LTA, ERS-12, CDS-1, MCM-65, MCM-47, 4A, 5A, UZM-5, UZM-9, UZM-25, AlPO-34, SAPO-44, SAPO-47, SAPO-17, CVX-7, SAPO-35, SAPO-56, AlPO-52, SAPO-43, medium pore molecular sieves such as Si-MFI, Si-BEA, Si-MEL, and large pore molecular sieves such as FAU, OFF, zeolite L, NaX, NaY, and CaY.

More preferably, the microporous molecular sieves used for the preparation of the UV cross-linked MMMs in the current invention are selected from, but are not limited to, small pore microporous alumino-phosphate molecular sieves such as AlPO-18 (3.8×3.8 Å), AlPO-14 (1.9×4.6 Å, 2.1×4.9 Å, and 3.3×4.0 Å), AlPO-52 (3.2×3.8 Å, 3.6×3.8 Å), and AlPO-17 (5.1×3.6 Å), small pore microporous aluminosilicate molecular sieves such as UZM-5 (3.2×3.2 Å, 3.6×4.4 Å), UZM-25 (2.5×4.2 Å, 3.1×4.7 Å), UZM-9 (3.8×3.8 Å), and small pore microporous silico-alumino-phosphate molecular sieves such as SAPO-34 (3.8×3.8 Å), SAPO-56 (3.4×3.6 Å), and mixtures thereof.

Another type of molecular sieves used in the UV cross-linked MMMs provided in this invention are mesoporous molecular sieves. Examples of preferred mesoporous molecular sieves include MCM-41 type of mesoporous materials, SBA-15, and surface functionalized MCM-41 and SBA-15.

Metal-organic frameworks (MOFs) can also be used as the molecular sieves in the UV cross-linked MMMs described in the present invention. MOFs are a new type of highly porous crystalline zeolite-like materials and are composed of rigid organic units assembled by metal-ligands. They possess vast accessible surface areas per unit mass. See Yaghi et al., SCIENCE, 295: 469 (2002); Yaghi et al., J. SOLID STATE CHEM., 152: 1 (2000); Eddaoudi et al., ACC. CHEM. RES., 34: 319 (2001); Russell et al., SCIENCE, 276: 575 (1997); Kiang et al., J. AM. CHEM. SOC., 121: 8204 (1999); Hoskins et al., J. AM. CHEM. SOC., 111: 5962 (1989); Li et al., NATURE, 402: 276 (1999); Serpaggi et al., J. MATER. CHEM., 8: 2749 (1998); Reineke et al., J. AM. CHEM. SOC., 122: 4843 (2000); Bennett et al., MATER. RES. BULL., 3: 633 (1968); Yaghi et al., J. AM. CHEM. SOC., 122: 1393 (2000); Yaghi et al., MICROPOR. MESOPOR. MATER., 73: 3 (2004); Dybtsev et al., ANGEW. CHEM. INT. ED., 43: 5033 (2004). MOF-5 is a prototype of a new class of porous materials constructed from octahedral Zn—O—C clusters and benzene links. Most recently, Yaghi et al. reported the systematic design and construction of a series of frameworks (IRMOF) that have structures based on the skeleton of MOF-5, wherein the pore functionality and size have been varied without changing the original cubic topology. For example, IRMOF-1 (Zn₄O(R₁-BDC)₃) has the same topology as that of MOF-5, but was synthesized by a simplified method. In 2001, Yaghi et al. reported the synthesis of a porous metal-organic polyhedron (MOP) Cu₂₄(m-BDC)₂₄(DMF)₁₄(H₂O)₅₀(DMF)₆(C₂H₅OH)₆, termed “α-MOP-1” and constructed from 12 paddle-wheel units bridged by m-BDC to give a large metal-carboxylate polyhedron. See Yaghi et al., 123: 4368 (2001). These MOF, IR-MOF and MOP materials exhibit analogous behaviour to that of conventional microporous materials such as large and accessible surface areas, with interconnected intrinsic micropores. Moreover, they may reduce the hydrocarbon fouling problem of the polyimide membranes due to relatively larger pore sizes than those of zeolite materials. MOF, IR-MOF and MOP materials are also expected to allow the polymer to infiltrate the pores, which would improve the interfacial and mechanical properties and would in turn affect permeability. Therefore, these MOF, IR-MOF and MOP materials (all termed “MOF” herein this invention) are used as molecular sieves in the preparation of UV cross-linked MMMs in the present invention.

The particle size of the molecular sieves dispersed in the continuous polymer matrix of the UV cross-linked MMMs in the present invention should be small enough to form a uniform dispersion of the particles in the concentrated suspensions from which the UV cross-linked MMMs will be fabricated. The median particle size should be less than about 10 μm, preferably less than 5 μm, and more preferably less than 1 μm. Most preferably, nano-molecular sieves (or “molecular sieve nanoparticles”) should be used in the UV cross-linked MMMs of the current invention.

Nano-molecular sieves described herein are sub-micron size molecular sieves with particle sizes in the range of 5 to 1000 nm. Nano-molecular sieve selection for the preparation of UV cross-linked MMMs includes screening the dispersity of the nano-molecular sieves in organic solvent, the porosity, particle size, and surface functionality of the nano-molecular sieves, the adhesion or wetting property of the nano-molecular sieves with the polymer matrix. Nano-molecular sieves for the preparation of UV cross-linked MMMs should have suitable pore size to allow selective permeation of a smaller sized gas, and also should have appropriate particle size in the nanometer range to prevent defects in the membranes. The nano-molecular sieves should be easily dispersed without agglomeration in the polymer matrix to maximize the transport property.

The nano-molecular sieves described herein are synthesized from initially clear solutions. Representative examples of nano-molecular sieves suitable to be incorporated into the UV cross-linked MMMs described herein include silicalite-1, SAPO-34, Si-MTW, Si-BEA, Si-MEL, LTA, FAU, Si-DDR, AlPO-14, AlPO-34, SAPO-56, AlPO-52, AlPO-18, SSZ-62, UZM-5, UZM-9, UZM-25, and MCM-65.

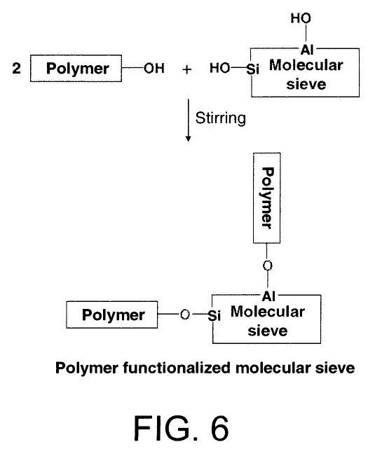

In the present invention, the molecular sieve particles dispersed in the concentrated suspension from which UV cross-linked MMMs are formed are functionalized by a suitable polymer, which results in the formation of either polymer-O-molecular sieve covalent bonds via reactions between the hydroxyl (—OH) groups on the surfaces of the molecular sieves and the hydroxyl (—OH) groups at the polymer chain ends or at the polymer side chains of the molecular sieve stabilizers such as PES (FIG. 6) or hydrogen bonds between the hydroxyl groups on the surfaces of the molecular sieves and the functional groups such as ether groups on the polymer chains. The surfaces of the molecular sieves in the concentrated suspensions contain many hydroxyl groups attached to silicon (if present), aluminum (if present) and phosphate (if present). These hydroxyl groups on the molecular sieves in the concentrated suspensions can affect long-term stability of the suspensions and phase separation kinetics of the MMMs. The stability of the concentrated suspensions refers to the characteristic of the molecular sieve particles remaining homogeneously dispersed in the suspension. A key factor in determining whether an aggregation of molecular sieve particles can be prevented and a stable suspension formed is the compatibility of these molecular sieve surfaces with the polymer matrix and the solvents in the suspensions. The functionalization of the surfaces of the molecular sieves using a suitable polymer described in the present invention provides good compatibility and an interface substantially free of voids and defects at the molecular sieve/polymer used to functionalize molecular sieves/polymer matrix interface. Therefore, voids and defects free UV cross-linked polymer functionalized molecular sieve/polymer MMMs with significant separation property enhancements over traditional polymer membranes and over those prepared from suspensions containing the same UV cross-linkable polymer matrix and same molecular sieves but without polymer functionalization have been successfully prepared using these stable polymer functionalized molecular sieve/polymer suspensions. An absence of voids and defects at the interface increases the likelihood that the permeating species will be separated by passing through the pores of the molecular sieves in the UV cross-linked MMMs rather than passing unseparated through voids and defects. Therefore, the UV cross-linked MMMs fabricated using the present invention combine the solution-diffusion mechanism of polymer membrane and the molecular sieving and sorption mechanism of molecular sieves (FIG. 5), and assure maximum selectivity and consistent performance among different membrane samples comprising the same molecular sieve/polymer composition.

The functions of the polymer used to functionalize the molecular sieve particles in the UV cross-linked MMMs of the present invention include: 1) forming good adhesion at the molecular sieve/polymer used to functionalize molecular sieves interface via hydrogen bonds or molecular sieve-O-polymer covalent bonds; 2) being an intermediate to improve the compatibility of the molecular sieves with the continuous UV cross-linked polymer matrix; 3) stabilizing the molecular sieve particles in the concentrated suspensions to remain homogeneously suspended. Any polymer that has these functions can be used to functionalize the molecular sieve particles in the concentrated suspensions from which UV cross-linked MMMs are formed. Preferably, the polymers used to functionalize the molecular sieves contain functional groups such as amino groups that can form hydrogen bonding with the hydroxyl groups on the surfaces of the molecular sieves. More preferably, the polymers used to functionalize the molecular sieves contain functional groups such as hydroxyl or isocyanate groups that can react with the hydroxyl groups on the surface of the molecular sieves to form polymer-O-molecular sieve covalent bonds. Thus, good adhesion between the molecular sieves and polymer is achieved. Representatives of such polymers are hydroxyl or amino group-terminated or ether polymers such as polyethersulfones (PESs), poly(hydroxyl styrene), sulfonated PESs, polyethers such as hydroxyl group-terminated poly(ethylene oxide)s, hydroxyl group-terminated poly(vinyl acetate), amino group-terminated poly(ethylene oxide)s, or isocyanate group-terminated poly(ethylene oxide)s, hydroxyl group-terminated poly(propylene oxide)s, hydroxyl group-terminated co-block-poly(ethylene oxide)-poly(propylene oxide)s, hydroxyl group-terminated tri-block-poly(propylene oxide)-block-poly(ethylene oxide)-block-poly(propylene oxide)s, tri-block-poly(propylene glycol)-block-poly(ethylene glycol)-block-poly(propylene glycol) bis(2-aminopropyl ether), polyether ketones, poly(ethylene imine)s, poly(amidoamine)s, poly(vinyl alcohol)s, poly(allyl amine)s, poly(vinyl amine)s, and polyetherimides such as Ultem (or Ultem 1000) sold under the trademark Ultem®, manufactured by GE Plastics, as well as hydroxyl group-containing glassy polymers such as cellulosic polymers including cellulose acetate, cellulose triacetate, cellulose acetate-butyrate, cellulose propionate, ethyl cellulose, methyl cellulose, and nitrocellulose.

The weight ratio of the molecular sieves to the polymer used to functionalize the molecular sieves in the UV cross-linked MMMs of the current invention can be within a broad range, but not limited to, from about 1:2 to 100:1 based on the polymer used to functionalize the molecular sieves, i.e. 5 weight parts of molecular sieve per 100 weight parts of polymer used to functionalize the molecular sieves to about 100 weight parts of molecular sieve per 1 weight part of polymer used to functionalize the molecular sieves depending upon the properties sought as well as the dispersibility of a particular molecular sieves in a particular suspension. Preferably the weight ratio of the molecular sieves to the polymer used to functionalize the molecular sieves in the UV cross-linked MMMs of the current invention is in the range from about 10:1 to 1:2.

The stabilized suspension contains polymer functionalized molecular sieve particles uniformly dispersed in the continuous polymer matrix. The UV cross-linked MMM, particularly dense film UV cross-linked MMM, asymmetric flat sheet UV cross-linked MMM, asymmetric thin-film composite MMM, or asymmetric hollow fiber UV cross-linked MMM, is fabricated from the stabilized suspension followed by UV cross-linking. The UV cross-linked MMM prepared by the present invention comprises uniformly dispersed polymer functionalized molecular sieve particles throughout the continuous UV cross-linked polymer matrix. The polymer that serves as the continuous polymer matrix in the UV cross-linked MMM of the present invention is a type of UV cross-linkable polymer and provides a wide range of properties important for separations, and modifying it can improve membrane selectivity. A material with a high glass transition temperature (Tg), high melting point, and high crystallinity is preferred for most gas separations. Glassy polymers (i.e., polymers below their Tg) have stiffer polymer backbones and therefore let smaller molecules such as hydrogen and helium permeate the membrane more quickly and larger molecules such as hydrocarbons permeate the membrane more slowly. For the UV cross-linked MMM applications in the present invention, the polymer matrix provides a wide range of properties important for membrane separations such as low cost and easy processability and should be selected from polymer materials, which can form cross-linked structure to further improve membrane selectivity. It is preferred that a comparable membrane fabricated from the pure polymer, exhibit a carbon dioxide or hydrogen over methane selectivity of at least about 10, more preferably at least about 15. Preferably, the polymer used as the continuous polymer matrix phase in the cross-linked MMMs is a UV cross-linkable rigid, glassy polymer. The weight ratio of the molecular sieves to the polymer that will serve as the continuous polymer matrix in the UV cross-linked MMM of the current invention can be within a broad range from about 1:100 (1 weight part of molecular sieves per 100 weight parts of the polymer that will serve as the continuous polymer matrix) to about 1:1 (100 weight parts of molecular sieves per 100 weight parts of the polymer that will serve as the continuous polymer matrix) depending upon the properties sought as well as the dispersibility of the particular molecular sieves in the particular continuous polymer matrix.

Typical polymers that will serve as the continuous polymer matrix phase suitable for the preparation of UV cross-linked MMMs comprise polymer chain segments wherein at least a part of these polymer chain segments can be UV cross-linked to each other through direct covalent bonds by exposure to UV radiation. The UV cross-linkable polymers can be selected from any polymers containing UV cross-linkable nitrile (—C≡N), benzophenone (—C₆H₄—C(═O)—C₆H₄—), acrylic (CH₂═C(COOH)— or —CH═C(COOH)—), vinyl (CH₂═CH—), styrenic (C₆H₅—CH═CH— or —C₆H₄—CH═CH₂), styrenic-acrylic, aryl sulfonyl (—C₆H₄—SO₂—C₆H₄—), 3,4-epoxycyclohexyl, and 2,3-dihydrofuran groups or mixtures of these groups. For example, these UV-cross-linkable polymers can be selected from, but is not limited to, polysulfones; sulfonated polysulfones; polyethersulfones (PESs); sulfonated PESs; polyacrylates; polyetherimides; poly(styrenes), including styrene-containing copolymers such as acrylonitrilestyrene copolymers, styrene-butadiene copolymers and styrene-vinylbenzylhalide copolymers; polyimides such as poly[1,2,4,5-benzenetetracarboxylic dianhydride-co-3,3′,4,4′-benzophenonetetracarboxylic dianhydride-co-4,4′-methylenebis(2,6-dimethylaniline)]imides (e.g., a polyimide with 1:1 ratio of 1,2,4,5-benzenetetracarboxylic dianhydride and 3,3′,4,4′-benzophenonetetracarboxylic dianhydride in this polyimide), Matrimid sold under the trademark Matrimid® by Huntsman Advanced Materials (Matrimid® 5218 refers to a particular polyimide polymer sold under the trademark Matrimid®), and P84 or P84HT sold under the tradename P84 and P84HT respectively from HP Polymers GmbH; polyamide/imides; polyketones, polyether ketones.

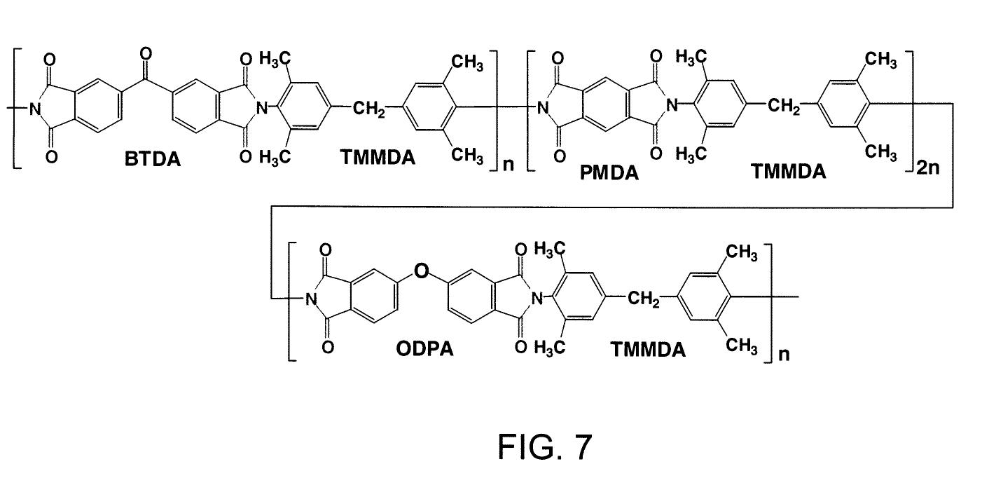

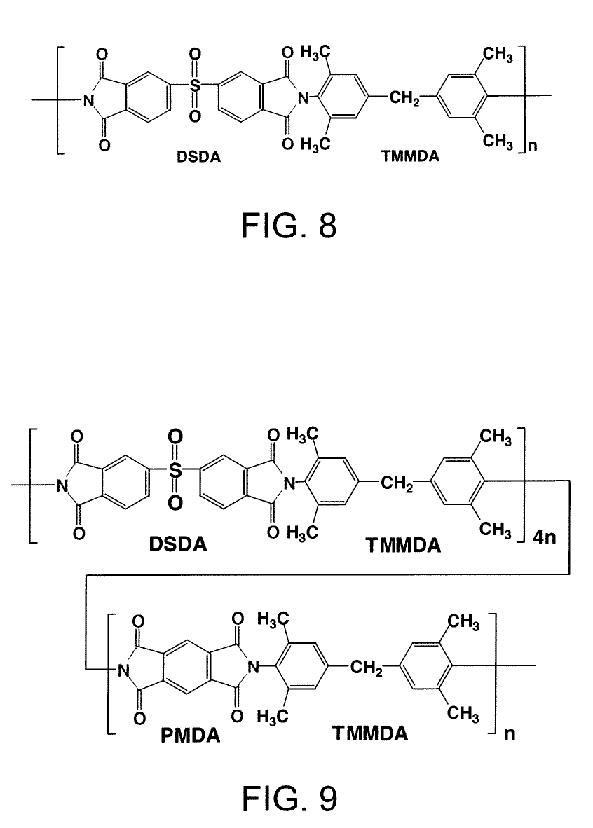

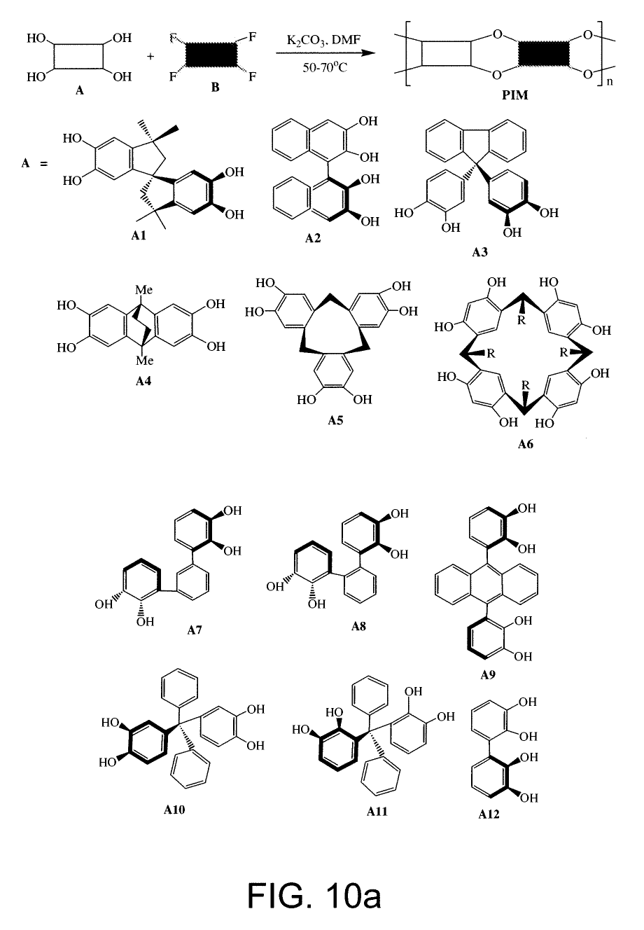

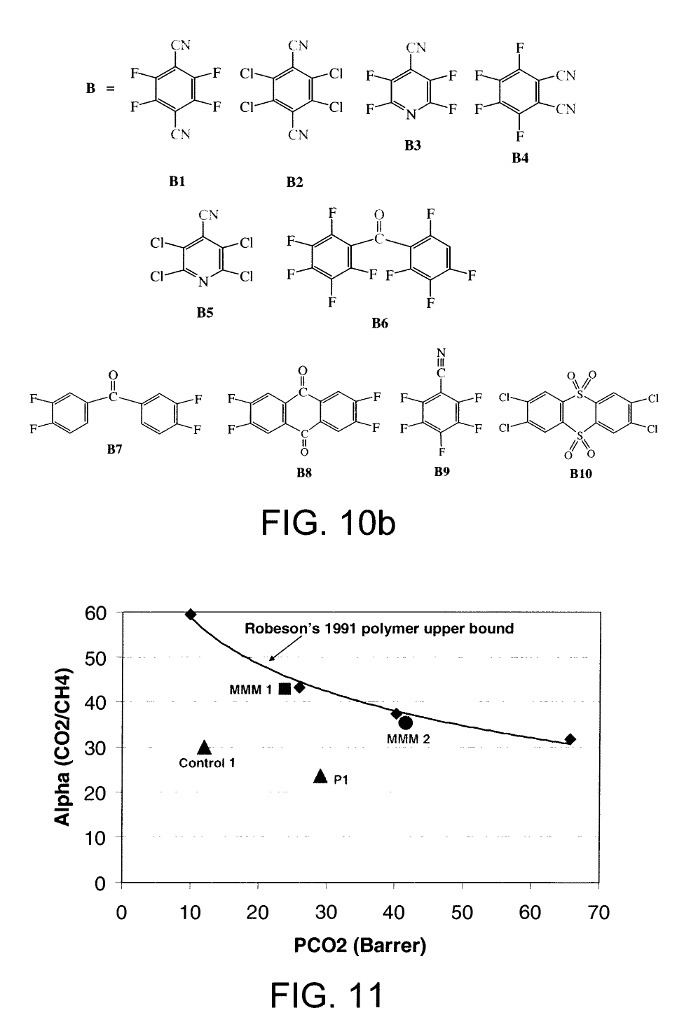

Some preferred UV cross-linkable polymers that will serve as the continuous polymer matrix phase suitable for the preparation of UV cross-linked MMMs include, but are not limited to, polyethersulfones (PESs); sulfonated PESs; polyimides such as Matrimid sold under the trademark Matrimid® by Huntsman Advanced Materials (Matrimid® 5218 refers to a particular polyimide polymer sold under the trademark Matrimid®), P84 or P84HT sold under the tradename P84 and P84HT respectively from HP Polymers GmbH, poly(3,3′,4,4′-benzophenone tetracarboxylic dianhydride-pyromellitic dianhydride-4,4′-oxydiphthalic anhydride-3,3′,5,5′-tetramethyl-4,4′-methylene dianiline) (poly(BTDA-PMDA-ODPA-TMMDA), FIG. 7), poly(3,3′,4,4′-diphenylsulfone tetracarboxylic dianhydride-3,3′,5,5′-tetramethyl-4,4′-methylene dianiline) (poly(DSDA-TMMDA), FIG. 8), poly(3,3′,4,4′-diphenylsulfone tetracarboxylic dianhydride-pyromellitic dianhydride-3,3′,5,5′-tetramethyl-4,4′-methylene dianiline) (poly(DSDA-PMDA-TMMDA), FIG. 9); and UV cross-linkable microporous polymers (FIGS. 10a and 10b).

The most preferred UV cross-linkable polymers that will serve as the continuous polymer matrix phase suitable for the preparation of UV cross-linked MMMs include, but are not limited to, PESs; polyimides such as Matrimid®, poly(BTDA-PMDA-ODPA-TMMDA), poly(DSDA-TMMDA), poly(DSDA-PMDA-TMMDA), and P84 or P84HT; and UV cross-linkable microporous polymers.

UV cross-linkable microporous polymers (or as so-called “polymers of intrinsic microporosity” See McKeown, et al., CHEM. COMMUN., 2780 (2002); McKeown, et al., CHEM. COMMUN., 2782 (2002); Budd, et al., J. MATER. CHEM., 13:2721 (2003); Budd, et al., CHEM. COMMUN., 230 (2004); Budd, et al., ADV. MATER., 16:456 (2004); McKeown, et al., CHEM. EUR. J., 11:2610 (2005)) described herein are polymeric materials that possess microporosity that is intrinsic to their molecular structures and also comprise polymer chain segments wherein at least a part of these polymer chain segments are UV-cross-linked to each other through direct covalent bonds by exposure to UV radiation. The UV-cross-linkable microporous polymers can be selected from any microporous polymers containing a UV-cross-linkable nitrile (—C≡N), benzophenone (—C₆H₄—C(═O)—C₆H₄—), acrylic (CH₂═C(COOH)— or —CH═C(COOH)—), vinyl (CH₂═CH—), styrenic (C₆H₅—CH═CH— or —C₆H₄—CH═CH₂), styrenic-acrylic, aryl sulfonyl (—C₆H₄—SO₂—C₆H₄—), 3,4-epoxycyclohexyl, and 2,3-dihydrofuran groups or mixtures of these groups. The structures of some representative UV-cross-linkable microporous polymers and their preparation are indicated in FIGS. 10a and 10b. This type of UV cross-linkable microporous polymers can be used as the continuous polymer matrix in the UV cross-linked MMMs in the current invention. The UV cross-linkable microporous polymers have a rigid rod-like, randomly contorted structure to generate intrinsic microporosity. These UV cross-linkable microporous polymers exhibit behavior analogous to that of conventional microporous molecular sieve materials, such as large and accessible surface areas, interconnected intrinsic micropores of less than 2 nm in size, as well as high chemical and thermal stability, but, in addition, possess properties of conventional polymers such as good solubility and easy processability. Moreover, these UV cross-linkable microporous polymers possess polyether polymer chains that have favorable interaction between carbon dioxide and the ethers.

The solvents used for dispersing the molecular sieve particles in the concentrated suspension and for dissolving the polymer used to functionalize the molecular sieves and the polymer that serves as the continuous polymer matrix are chosen primarily for their ability to completely dissolve the polymers and for ease of solvent removal in the membrane formation steps. Other considerations in the selection of solvents include low toxicity, low corrosive activity, low environmental hazard potential, availability and cost. Representative solvents for use in this invention include most amide solvents that are typically used for the formation of polymeric membranes, such as N-methylpyrrolidone (NMP) and N,N-dimethyl acetamide (DMAC), methylene chloride, THF, acetone, DMF, DMSO, toluene, dioxanes, 1,3-dioxolane, mixtures thereof, others known to those skilled in the art and mixtures thereof.

In the present invention, the UV cross-linked MMMs can be fabricated with various membrane structures such as UV cross-linked mixed matrix dense films, asymmetric flat sheet UV cross-linked MMMs, asymmetric thin film composite UV cross-linked MMMs, or asymmetric hollow fiber UV cross-linked MMMs from the stabilized concentrated suspensions containing a mixture of solvents, polymer functionalized molecular sieves, and a continuous polymer matrix. For example, the suspension can be sprayed, spin coated, poured into a sealed glass ring on top of a clean glass plate, or cast with a doctor knife. In another method, a porous substrate can be dip coated with the suspension. One solvent removal technique used in the present invention is the evaporation of volatile solvents by ventilating the atmosphere above the forming membrane with a diluent dry gas and drawing a vacuum. Another solvent removal technique used in the present invention calls for immersing the cast thin layer of the concentrated suspension (previously cast on a glass plate or on a porous or permeable substrate) in a non-solvent for the polymers that is miscible with the solvents of the suspension. To facilitate the removal of the solvents, the substrate and/or the atmosphere or non-solvent into which the thin layer of dispersion is immersed can be heated. When the UV cross-linkable MMM is substantially free of solvents, it can be detached from the glass plate to form a free-standing (or self-supporting) structure or the UV cross-linkable MMM can be left in contact with a porous or permeable support substrate to form an integral composite assembly. Additional fabrication steps that can be used include washing the UV cross-linkable MMM in a bath of an appropriate liquid to extract residual solvents and other foreign matters from the membrane, drying the washed UV cross-linkable MMM to remove residual liquid. In some cases the UV cross-linkable MMMs were coated with a thin layer of material such as a UV radiation curable epoxy silicon to fill the surface voids and defects on the UV cross-linkable MMMs.

The UV cross-linked MMMs were then prepared by further UV cross-linking the UV cross-linkable MMMs or the UV cross-linkable MMMs with a thin layer of coating using a UV lamp from a certain distance and for a period of time selected based upon the separation properties sought. For example, UV cross-linked MMMs can be prepared from UV cross-linkable MMMs by exposure to UV radiation using 254 nm wavelength UV light generated from a UV lamp with 1.9 cm (0.75 inch) distance from the membrane surface to the UV lamp and a radiation time of 30 min at less than 50° C. The UV lamp described here is a low pressure, mercury arc immersion UV quartz 12 watt lamp with 12 watt power supply from Ace Glass Incorporated. Optimization of the cross-linking degree in the UV cross-linked MMMs should promote the tailoring of membranes for a wide range of gas and liquid separations with improved permeation properties and environmental stability. The cross-linking degree of the UV-cross-linked MMMs of the present invention can be controlled by adjusting the distance between the UV lamp and the membrane surface, UV radiation time, wavelength and strength of UV light, etc. Preferably, the distance from the UV lamp to the membrane surface is in the range of 0.8 to 25.4 cm (0.3 to 10 inches) with a UV light provided from 12 watt to 450 watt low pressure or medium pressure mercury arc lamp, and the UV radiation time is in the range of 1 min to 1 h. More preferably, the distance from the UV lamp to the membrane surface is in the range of 1.3 to 5.1 cm (0.5 to 2 inches) with a UV light provided from 12 watt to 450 watt low pressure or medium pressure mercury arc lamp, and the UV radiation time is in the range of 1 to 40 minutes.

In some cases, the UV cross-linked MMMs were further coated with a thin layer of material such as a polysiloxane, a fluoro-polymer, or a thermally curable silicon rubber to fill the surface voids and defects on the UV cross-linked MMMs.

One preferred embodiment of the current invention is in the form of an asymmetric flat sheet UV cross-linked MMM for gas separation comprising a smooth thin dense selective layer on top of a highly porous supporting layer. Another preferred embodiment of the current invention is in the form of an asymmetric hollow fiber UV cross-linked MMM for gas separation comprising a smooth thin dense selective layer on top of a highly porous supporting layer.

The method of the present invention for producing high performance UV cross-linked MMMs is suitable for large scale membrane production and can be integrated into commercial polymer membrane manufacturing process. The UV cross-linked MMMs, particularly dense film MMMs, asymmetric flat sheet MMMs, asymmetric thin-film composite MMMs, or asymmetric hollow fiber UV cross-linked MMMs, fabricated by the method described in the current invention exhibit significantly enhanced selectivity and/or permeability over polymer membranes prepared from their corresponding polymer matrices and over those prepared from suspensions containing the same polymer matrix and same molecular sieves but without polymer functionalization.

The current invention provides a process for separating at least one gas from a mixture of gases using the UV cross-linked MMMs described in the present invention, the process comprising: (a) providing a UV cross-linked MMM comprising a polymer functionalized molecular sieve filler material uniformly dispersed in a continuous UV cross-linked polymer matrix which is permeable to said at least one gas; (b) contacting the mixture on one side of the UV cross-linked MMM to cause said at least one gas to permeate the UV cross-linked MMM; and (c) removing from the opposite side of the membrane a permeate gas composition comprising a portion of said at least one gas which permeated said membrane.

The UV cross-linked MMMs of the present invention are suitable for a variety of gas, vapor, and liquid separations, and particularly suitable for gas and vapor separations such as separations of CO₂/CH₄, H₂/CH₄, O₂/N₂, CO₂/N₂, olefin/paraffin, and iso/normal paraffins.

The UV cross-linked MMMs of the present invention are especially useful in the purification, separation or adsorption of a particular species in the liquid or gas phase. In addition to separation of pairs of gases, these UV cross-linked MMMs may, for example, be used for the separation of proteins or other thermally unstable compounds, e.g. in the pharmaceutical and biotechnology industries. The UV cross-linked MMMs may also be used in fermenters and bioreactors to transport gases into the reaction vessel and transfer cell culture medium out of the vessel. Additionally, the UV cross-linked MMMs may be used for the removal of microorganisms from air or water streams, water purification, ethanol production in a continuous fermentation/membrane pervaporation system, and in detection or removal of trace compounds or metal salts in air or water streams.

The UV cross-linked MMMs of the present invention are especially useful in gas separation processes in air purification, petrochemical, refinery, and natural gas industries. Examples of such separations include separation of volatile organic compounds (such as toluene, xylene, and acetone) from an atmospheric gas, such as nitrogen or oxygen and nitrogen recovery from air. Further examples of such separations are for the separation of CO₂ from natural gas, H₂ from N₂, CH₄, and Ar in ammonia purge gas streams, H₂ recovery in refineries, olefin/paraffin separations such as propylene/propane separation, and iso/normal paraffin separations. Any given pair or group of gases that differ in molecular size, for example nitrogen and oxygen, carbon dioxide and methane, hydrogen and methane or carbon monoxide, helium and methane, can be separated using the UV cross-linked MMMs described herein. More than two gases can be removed from a third gas. For example, some of the gas components which can be selectively removed from a raw natural gas using the membrane described herein include carbon dioxide, oxygen, nitrogen, water vapor, hydrogen sulfide, helium, and other trace gases. Some of the gas components that can be selectively retained include hydrocarbon gases.

The UV cross-linked MMMs described in the current invention are also especially useful in gas/vapor separation processes in chemical, petrochemical, pharmaceutical and allied industries for removing organic vapors from gas streams, e.g. in off-gas treatment for recovery of volatile organic compounds to meet clean air regulations, or within process streams in production plants so that valuable compounds (e.g., vinylchloride monomer, propylene) may be recovered. Further examples of gas/vapor separation processes in which these UV cross-linked MMMs may be used are hydrocarbon vapor separation from hydrogen in oil and gas refineries, for hydrocarbon dew pointing of natural gas (i.e. to decrease the hydrocarbon dew point to below the lowest possible export pipeline temperature so that liquid hydrocarbons do not separate in the pipeline), for control of methane number in fuel gas for gas engines and gas turbines, and for gasoline recovery. The UV cross-linked MMMs may incorporate a species that adsorbs strongly to certain gases (e.g. cobalt porphyrins or phthalocyanines for O₂ or silver(I) for ethane) to facilitate their transport across the membrane.

These UV cross-linked MMMs may also be used in the separation of liquid mixtures by pervaporation, such as in the removal of organic compounds (e. g., alcohols, phenols, chlorinated hydrocarbons, pyridines, ketones) from water such as aqueous effluents or process fluids. A membrane which is ethanol-selective would be used to increase the ethanol concentration in relatively dilute ethanol solutions (5-10% ethanol) obtained by fermentation processes. Another liquid phase separation example using these UV cross-linked MMMs is the deep desulfurization of gasoline and diesel fuels by a pervaporation membrane process similar to the process described in U.S. Pat. No. 7,048,846 B2, incorporated by reference herein in its entirety. The UV cross-linked MMMs that are selective to sulfur-containing molecules would be used to selectively remove sulfur-containing molecules from fluid catalytic cracking (FCC) and other naphtha hydrocarbon streams. Further liquid phase examples include the separation of one organic component from another organic component, e. g. to separate isomers of organic compounds. Mixtures of organic compounds which may be separated using an inventive membrane include: ethylacetate-ethanol, diethylether-ethanol, acetic acid-ethanol, benzene-ethanol, chloroform-ethanol, chloroform-methanol, acetone-isopropylether, allylalcohol-allylether, allylalcohol-cyclohexane, butanol-butylacetate, butanol-1-butylether, ethanol-ethylbutylether, propylacetate-propanol, isopropylether-isopropanol, methanol-ethanol-isopropanol, and ethylacetate-ethanol-acetic acid.

The UV cross-linked MMMs may be used for separation of organic molecules from water (e.g. ethanol and/or phenol from water by pervaporation) and removal of metal and other organic compounds from water.

An additional application of the UV cross-linked MMMs is in chemical reactors to enhance the yield of equilibrium-limited reactions by selective removal of a specific product in an analogous fashion to the use of hydrophilic membranes to enhance esterification yield by the removal of water.

The present invention pertains to novel voids and defects free UV cross-linked polymer functionalized molecular sieve/polymer mixed matrix membranes (MMMs) fabricated from stable concentrated suspensions containing uniformly dispersed polymer functionalized molecular sieves and the continuous polymer matrix. These new UV cross-linked MMMs have immediate applications for the separation of gas mixtures including carbon dioxide removal from natural gas. UV cross-linked MMM permits carbon dioxide to diffuse through at a faster rate than the methane in the natural gas. Carbon dioxide has a higher permeation rate than methane because of higher solubility, higher diffusivity, or both. Thus, carbon dioxide enriches on the permeate side of the membrane, and methane enriches on the feed (or reject) side of the membrane.

Any given pair of gases that differ in size, for example, nitrogen and oxygen, carbon dioxide and methane, carbon dioxide and nitrogen, hydrogen and methane or carbon monoxide, helium and methane, can be separated using the UV cross-linked MMMs described herein. More than two gases can be removed from a third gas. For example, some of the components which can be selectively removed from a raw natural gas using the membranes described herein include carbon dioxide, oxygen, nitrogen, water vapor, hydrogen sulfide, helium, and other trace gases. Some of the components that can be selectively retained include hydrocarbon gases.

The membrane process of the invention is useful to produce high quality naphtha products having a reduced sulfur content and a high olefin content. In accordance with the process of the invention, a naphtha feed containing olefins and sulfur containing-aromatic hydrocarbon compounds and sulfur containing-nonaromatic hydrocarbon compounds, is conveyed over a membrane separation zone to reduce sulfur content. The membrane separation zone comprises a membrane having a sufficient flux and selectivity to separate the feed into a sulfur deficient retentate fraction and a permeate fraction enriched in both aromatic and non-aromatic sulfur containing hydrocarbon compounds as compared to the initial naphtha feed. The naphtha feed is in a liquid or substantially liquid form.

For purposes of this invention, the term “naphtha” is used herein to indicate hydrocarbon streams found in refinery operations that have a boiling range between about 50° to about 220° C. Preferably, the naphtha is not hydrotreated prior to use in the invention process. Typically, the hydrocarbon streams will contain greater than 150 ppm, preferably from about 150 to about 3000 ppm, most preferably from about 300 to about 1000 ppm, sulfur.

The term “aromatic hydrocarbon compounds” is used herein to designate a hydrocarbon-based organic compound containing one or more aromatic rings, e.g. fused and/or bridged. An aromatic ring is typified by benzene having a single aromatic nucleus. Aromatic compounds having more than one aromatic ring include, for example, naphthalene, anthracene, etc. Preferred aromatic hydrocarbons useful in the present invention include those having 1 to 2 aromatic rings. The term “non-aromatic hydrocarbon” is used herein to designate a hydrocarbon-based organic compound having no aromatic nucleus. For the purposes of this invention, the term “hydrocarbon” is used to mean an organic compound having a predominately hydrocarbon character. It is contemplated within the scope of this definition that a hydrocarbon compound may contain at least one non-hydrocarbon radical (e.g. sulfur or oxygen) provided that said non-hydrocarbon radical does not alter the predominant hydrocarbon nature of the organic compound and/or does not react to alter the chemical nature of the membrane within the context of the present invention. For purposes of this invention, the term “sulfur enrichment factor” is used herein to indicate the ratio of the sulfur content in the permeate divided by the sulfur content in the feed.

The sulfur deficient retentate fraction obtained using the membrane process of the invention typically contains less than 100 ppm, preferably less than 50 ppm, and most preferably, less than 30 ppm sulfur. In a preferred embodiment, the sulfur content of the recovered retentate stream is from less than 30 wt-%, preferably less than 20 wt-%, and most preferably less than 10 wt-% of the initial sulfur content of the feed.

### EXAMPLES

The following examples are provided to illustrate one or more preferred embodiments of the invention, but are not limited embodiments thereof. Numerous variations can be made to the following examples that lie within the scope of the invention.

### Example 1

### Preparation of UV Cross-Linkable Poly(DSDA-PMDA-TMMDA)-PES Polymer Membrane (Abbreviated as P1)

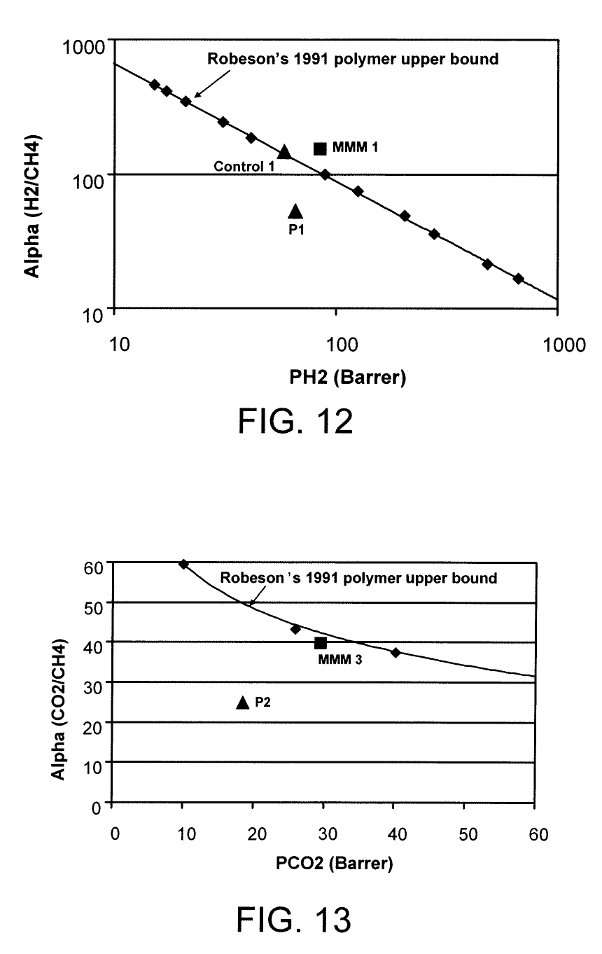

5.4 g of poly(DSDA-PMDA-TMMDA) polyimide polymer (FIG. 9) and 0.6 g of polyethersulfone (PES) were dissolved in a certain amount of an organic solvent or a mixture of several organic solvents (e.g. a solvent mixture of NMP, acetone, and 1,3-dioxolane) by mechanical stirring to form a homogeneous casting dope. The resulting homogeneous casting dope was allowed to degas overnight. A poly(DSDA-PMDA-TMMDA) polymer membrane was prepared from the bubble free casting dope on a clean glass plate using a doctor knife with a 20-mil gap. The film together with the glass plate was then put into a vacuum oven. The solvents were removed by slowly increasing the vacuum and the temperature of the vacuum oven. Finally, the membrane was dried at 200° C. under vacuum for at least 48 h to completely remove the residual solvents to form P1 polymer membrane as described in Tables 1 and 2, and FIGS. 11 and 12).

### Example 2

### Preparation of UV Cross-Linked Poly(DSDA-PMDA-TMMDA)-PES Polymer Membrane (Abbreviated as Control 1)

The Control 1 polymer membrane as described in Tables 1 and 2, and FIGS. 11 and 12 was prepared by further UV cross-linking P1 polymer membrane by exposure to UV radiation using 254 nm wavelength UV light generated from a UV lamp with 1.9 cm (0.75 inch) distance from the membrane surface to the UV lamp and a radiation time of 10 min at 50° C. The UV lamp described here is a low pressure, mercury arc immersion UV quartz 12 watt lamp with 12 watt power supply from Ace Glass Incorporated.

### Example 3

### Preparation of UV Cross-Linked 30% AlPO-14/PES/Poly(DSDA-PMDA-TMMDA) Mixed Matrix Membrane (Abbreviated as MMM 1)

UV cross-linked polyethersulfone (PES) functionalized AlPO-14/poly(DSDA-PMDA-TMMDA) mixed matrix membrane (MMM 1) containing 30 wt-% of dispersed AlPO-14 molecular sieve fillers in UV cross-linked poly(DSDA-PMDA-TMMDA) polyimide continuous matrix (UV cross-linked 30% AlPO-14/PES/poly(DSDA-PMDA-TMMDA)) was prepared as follows:

1.8 g of AlPO-14 molecular sieves were dispersed in a mixture of NMP and 1,3-dioxolane by mechanical stirring and ultrasonication for 1 h to form a slurry. Then 0.6 g of PES was added to functionalize AlPO-14 molecular sieves in the slurry. The slurry was stirred for at least 1 h to completely dissolve PES polymer and functionalize the surface of AlPO-14. After that, 5.6 g of poly(DSDA-PMDA-TMMDA) polyimide polymer was added to the slurry and the resulting mixture was stirred for another 2 h to form a stable casting dope containing 30 wt-% of dispersed PES functionalized AlPO-14 molecular sieves (weight ratio of AlPO-14 to poly(DSDA-PMDA-TMMDA) and PES is 30:100; weight ratio of PES to poly(DSDA-PMDA-TMMDA) is 1:9) in the continuous poly(DSDA-PMDA-TMMDA) polymer matrix. The stable casting dope was allowed to degas overnight.

A UV cross-linkable 30% AlPO-14/PES/poly(DSDA-PMDA-TMMDA) mixed matrix membrane was prepared on a clean glass plate from the bubble free stable casting dope using a doctor knife with a 20-mil gap. The film together with the glass plate was then put into a vacuum oven. The solvents were removed by slowly increasing the vacuum and the temperature of the vacuum oven. Finally, the membrane was dried at 200° C. under vacuum for at least 48 h to completely remove the residual solvents to form UV cross-linkable 30% AlPO-14/PES/poly(DSDA-PMDA-TMMDA) mixed matrix membrane.

The MMM 1 membrane as described in Tables 1 and 2, and FIGS. 11 and 12 was prepared by further UV cross-linking the 30% AlPO-14/PES/poly(DSDA-PMDA-TMMDA) mixed matrix membrane by exposure to UV radiation using 254 nm wavelength UV light generated from a UV lamp with 1.9 cm (0.75 inch) distance from the membrane surface to the UV lamp and a radiation time of 10 min at 50° C. The UV lamp described here is a low pressure, mercury arc immersion UV quartz 12 watt lamp with 12 watt power supply from Ace Glass Incorporated.

### Example 4

### Preparation of UV Cross-Linked 40% AlPO-14/PES/Poly(DSDA-PMDA-TMMDA) Mixed Matrix Membrane (Abbreviated as MMM 2)

UV cross-linked polyethersulfone (PES) functionalized AlPO-14/poly(DSDA-PMDA-TMMDA) mixed matrix membrane (MMM 2) containing 40 wt-% of dispersed AlPO-14 molecular sieve fillers in UV cross-linked poly(DSDA-PMDA-TMMDA) polyimide continuous matrix was prepared as follows:

2.4 g of AlPO-14 molecular sieves were dispersed in a mixture of NMP and 1,3-dioxolane by mechanical stirring and ultrasonication to form a slurry. Then 0.6 g of PES was added to functionalize AlPO-14 molecular sieves in the slurry. The slurry was stirred for at least 1 h to completely dissolve PES polymer and functionalize the surface of AlPO-14. After that, 5.6 g of poly(DSDA-PMDA-TMMDA) polyimide polymer was added to the slurry and the resulting mixture was stirred for another 2 h to form a stable casting dope containing 40 wt-% of dispersed PES functionalized AlPO-14 molecular sieves (weight ratio of AlPO-14 to poly(DSDA-PMDA-TMMDA) and PES is 40:100; weight ratio of PES to poly(DSDA-PMDA-TMMDA) is 1:9) in the continuous poly(DSDA-PMDA-TMMDA) polymer matrix. The stable casting dope was allowed to degas overnight.

A 40% AlPO-14/PES/poly(DSDA-PMDA-TMMDA) mixed matrix membrane was prepared on a clean glass plate from the bubble free stable casting dope using a doctor knife with a 20-mil gap. The film together with the glass plate was then put into a vacuum oven. The solvents were removed by slowly increasing the vacuum and the temperature of the vacuum oven. Finally, the membrane was dried at 200° C. under vacuum for at least 48 h to completely remove the residual solvents to form 40% AlPO-14/PES/poly(DSDA-PMDA-TMMDA) mixed matrix membrane.

The MMM 2 membrane as described in Tables 1 and 2, and FIGS. 10a and 10b and FIG. 11) was prepared by further UV cross-linking the 40% AlPO-14/PES/poly(DSDA-PMDA-TMMDA) mixed matrix membrane by exposure to UV radiation using 254 nm wavelength UV light generated from a UV lamp with 1.9 cm (0.75 inch) distance from the membrane surface to the UV lamp and a radiation time of 10 min at 50° C. The UV lamp described here is a low pressure, mercury arc immersion UV quartz 12 watt lamp with 12 watt power supply from Ace Glass Incorporated.

### Example 5

### CO₂/CH₄ separation properties of P1, Control 1, MMM 1 and MMM 2 membranes

The permeabilities of CO₂ and CH₄ (P_{CO2} and P_{CH4}) and selectivity of CO₂/CH₄ (α_{CO2/CH4}) of P1 polymer membrane prepared in Example 1, Control 1 prepared in Example 2, MMM 1 prepared in Example 3, and MMM 2 prepared in Example 4 were measured by pure gas measurements at 50° C. under about 690 kPa (100 psig) pressure. The results for CO₂/CH₄ separation are shown in Table 1 and FIG. 11.

It can be seen from Table 1 and FIG. 11 that the UV cross-linked Control 1 polymer membrane showed 27% increase in α_{CCO2/CH4}, but P_{CO2} decreased by about 60% compared to P1 polymer membrane. The α_{CO2/CH4} of the UV cross-linked MMM 1 membrane increased to 43 and improved about 80% compared to that of P1 polymer membrane. The UV cross-linked MMM 2 membrane containing 40 wt-% AlPO-14 molecular sieve fillers in the UV cross-linked poly(DSDA-PMDA-TMMDA) polymer matrix showed simultaneous α_{CO2/CH4} increase by 50% and P_{CO2} increase by about 40% compared to P1 polymer membrane for CO₂/CH₄ separation, suggesting that AlPO-14 is a suitable molecular sieve filler (micro pore size: 1.9×4.6 Å, 2.1×4.9 Å, and 3.3×4.0 Å) with molecular sieving mechanism for the preparation of high selectivity molecular sieve/polymer mixed matrix membranes for CO₂/CH₄ gas separation. These testing results indicate a successful combination of molecular sieving mechanism of AlPO-14 molecular sieve fillers with the solution-diffusion mechanism of the UV cross-linked poly(DSDA-PMDA-TMMDA) polyimide matrix in this mixed matrix membrane for CO₂/CH₄ gas separation.

FIG. 11 shows CO₂/CH₄ separation performance of P1, Control 1, MMM 1, and MMM 2 at 50° C. and 690 kPa (100 psig), as well as Robeson's 1991 polymer upper limit data for CO₂/CH₄ separation at 35° C. and 345 kPa (50 psig) from literature (see Robeson, J. MEMBR. SCI., 62: 165 (1991)). It can be seen that the CO₂/CH₄ separation performances of P1 polymer membrane and the UV cross-linked Control 1 polymer membrane are far below Robeson's 1991 polymer upper bound for CO₂/CH₄ separation. The UV cross-linked MMM 1 and MMM 2 mixed matrix membranes, however, showed significantly CO₂/CH₄ separation performances that almost reach Robeson's 1991 polymer upper bound for CO₂/CH₄ separation. These results indicate that the novel voids and defects free UV cross-linked MMM 1 and MMM 2 membranes are very promising membrane candidates for the removal of CO₂ from natural gas or flue gas. The improved performance of MMM 1 and MMM 2 over P1 and Control 1 polymer membranes is attributed to the successful combination of molecular sieving mechanism of AlPO-14 molecular sieve fillers with the solution-diffusion mechanism of the UV cross-linked poly(DSDA-PMDA-TMMDA) polyimide matrix.

TABLE 1
Pure gas permeation test results of P1, Control 1, MMM 1, and
MMM 2 membranes for CO₂/CH₄ separation^{a}

| | P_{CO2} | ΔP_{CO2} | | |
|---|---|---|---|---|
| Membrane | (Barrer) | (Barrer) | α_{CO2/CH4} | Δα_{CO2/CH4} |
| P1 | 29.3 | 0 | 23.6 | 0 |
| Control 1 | 12.0 | −59% | 30.0 | 27% |
| MMM 1 | 23.7 | −19% | 43.1 | 83% |
| MMM 2 | 41.6 | 42% | 35.3 | 50% |

^{a}Tested at 50° C. under 690 kPa (100 psig) pure gas pressure;
1 Barrer = 10⁻¹⁰ (cm³(STP) · cm)/(cm² · sec · cmHg)

### Example 6

### H₂/CH₄ Separation Properties of P1, Control 1, and MMM 1 membranes

The permeabilities of H₂ and CH₄ (P_{H2} and P_{CH4}) and selectivity of H₂/CH₄ (α_{H2/CH4}) of P1 polymer membrane prepared in Example 1, Control 1 prepared in Example 2, and UV cross-linked MMM 1 mixed matrix membrane prepared in Example 3 were measured by pure gas measurements at 50° C. under about 690 kPa (100 psig) pressure. The results for H₂/CH₄ separation are shown in Table 2 and FIG. 12.

It can be seen from Table 2 and FIG. 12 that the UV cross-linked Control 1 polymer membrane showed 178% increase in α_{H2/CH4} with about a 10% decrease in P_{H2} compared to P1 membrane. The UV cross-linked MMM 1 containing 30 wt-% AlPO-14 molecular sieve fillers in the UV cross-linked poly(DSDA-PMDA-TMMDA) polymer matrix, however, showed simultaneous α_{H2/CH4} increase by about 190% and P_{H2} increase by 30% compared to P1 polymer membrane for H₂/CH₄ separation, demonstrating a successful combination of molecular sieving mechanism of AlPO-14 molecular sieve fillers with the solution-diffusion mechanism of the UV cross-linked poly(DSDA-PMDA-TMMDA) polyimide matrix in this mixed matrix membrane for H₂/CH₄ gas separation.

FIG. 12 shows H₂/CH₄ separation performance of P1, Control 1, and MMM 1 membranes at 50° C. and 690 kPa (100 psig), as well as Robeson's 1991 polymer upper limit data for H₂/CH₄ separation at 35° C. and 345 kPa (50 psig) from literature (see Robeson, J. Membr. Sci., 62: 165 (1991)). It can be seen that the H₂/CH₄ separation performances of P1 polymer membrane is far below Robeson's 1991 polymer upper bound for CO₂/CH₄ separation. The Control 1 polymer membrane showed improved H₂/CH₄ separation performance compared to P1 polymer membrane and its H₂/CH₄ separation performance reached Robeson's 1991 polymer upper bound for H₂/CH₄ separation. The UV cross-linked MMM 1 mixed matrix membrane showed further significantly improved H₂/CH₄ separation performance compared to Control 1 polymer membrane and its H₂/CH₄ separation performance is far beyond Robeson's 1991 polymer upper bound for H₂/CH₄ separation. These results indicate that the novel voids and defects free UV cross-linked MMM 1 mixed matrix membrane is a very promising membrane candidate for the removal of H₂ from natural gas.

TABLE 2
Pure gas permeation test results of P1, Control 1, and MMM 1
membranes for H₂/CH₄ separation^{a}

| | P_{H2} | ΔP_{H2} | | |
|---|---|---|---|---|
| Membrane | (Barrer) | (Barrer) | α_{H2/CH4} | Δα_{H2/CH4} |
| P1 | 65.6 | 0 | 52.9 | 0 |
| Control 1 | 58.6 | −11% | 147.0 | 178% |
| MMM 1 | 85.0 | 30% | 154.2 | 191% |

^{a}Tested at 50° C. under 690 kPa (100 psig) pure gas pressure;
1 Barrer = 10⁻¹⁰ (cm³(STP) · cm)/(cm² · sec · cmHg)

### Example 7

### Preparation of Poly(DSDA-TMMDA)-PES Polymer Membrane (Abbreviated as P2)

7.2 g of poly(DSDA-TMMDA) polyimide polymer (FIG. 8) and 0.8 g of polyethersulfone (PES) were dissolved in a solvent mixture of NMP and 1,3-dioxolane by mechanical stirring to form a homogeneous casting dope. The resulting homogeneous casting dope was allowed to degas overnight. A P2 polymer membrane was prepared from the bubble free casting dope on a clean glass plate using a doctor knife with a 20-mil gap. The membrane together with the glass plate was then put into a vacuum oven. The solvents were removed by slowly increasing the vacuum and the temperature of the vacuum oven. Finally, the membrane was dried at 200° C. under vacuum for at least 48 h to completely remove the residual solvents to form P2 as described in Table 3 and FIG. 13.

### Example 8

### Preparation of UV Cross-Linked 40% AlPO-14/PES/Poly(DSDA-TMMDA) Mixed Matrix Membrane (Abbreviated as MMM 3)

A UV cross-linked polyethersulfone (PES) functionalized AlPO-14/poly(DSDA-TMMDA) mixed matrix membrane (MMM 3) containing 40 wt-% of dispersed AlPO-14 molecular sieve fillers in a UV cross-linked poly(DSDA-TMMDA) polyimide continuous matrix was prepared as follows:

3.2 g of AlPO-14 molecular sieves were dispersed in a mixture of NMP and 1,3-dioxolane by mechanical stirring and ultrasonication for 1 h to form a slurry. Then 0.8 g of PES was added to functionalize AlPO-14 molecular sieves in the slurry. The slurry was stirred for at least 1 h to completely dissolve PES polymer and functionalize the surface of AlPO-14. After that, 7.2 g of poly(DSDA-TMMDA) polyimide polymer was added to the slurry and the resulting mixture was stirred for another 2 h to form a stable casting dope containing 40 wt-% of dispersed PES functionalized AlPO-14 molecular sieves (weight ratio of AlPO-14 to poly(DSDA-TMMDA) and PES is 40:100; weight ratio of PES to poly(DSDA-TMMDA) is 1:9) in the continuous poly(DSDA-TMMDA) polymer matrix. The stable casting dope was allowed to degas overnight.

A 40% AlPO-14/PES/poly(DSDA-TMMDA) mixed matrix membrane was prepared on a clean glass plate from the bubble free stable casting dope using a doctor knife with a 20-mil gap. The film together with the glass plate was then put into a vacuum oven. The solvents were removed by slowly increasing the vacuum and the temperature of the vacuum oven. Finally, the membrane was dried at 200° C. under vacuum for at least 48 h to completely remove the residual solvents to form 40% AlPO-14/PES/poly(DSDA-TMMDA) mixed matrix membrane.

A MMM 3 was prepared by further UV cross-linking the 40% AlPO-14/PES/poly(DSDA-TMMDA) mixed matrix membrane by exposure to UV radiation using 254 nm wavelength UV light generated from a UV lamp with 1.9 cm (0.75 inch) distance from the membrane surface to the UV lamp and a radiation time of 10 min at 50° C. The UV lamp described here is a low pressure, mercury arc immersion UV quartz 12 watt lamp with 12 watt power supply from Ace Glass Incorporated.

### Example 9

### CO₂/CH₄ Separation Properties of P2 and MMM 3 Membranes

The permeabilities of CO₂ and CH₄ (P_{CO2} and P_{CH4}) and selectivity of CO₂/CH₄ (α_{CO2/CH4}) of P2 polymer membrane prepared in Example 7 and UV cross-linked MMM 3 mixed matrix membrane prepared in Example 8 were measured by pure gas measurements at 50° C. under about 690 kPa (100 psig) pressure. The results for CO₂/CH₄ separation are shown in Table 3 and FIG. 13.

It can be seen from Table 3 and FIG. 13 that the UV cross-linked MMM 3 membrane containing 40 wt-% AlPO-14 molecular sieve fillers in the UV cross-linked poly(DSDA-TMMDA) polymer matrix showed simultaneous α_{CO2/CH4} and P_{CO2} increase by 60% compared to P2 polymer membrane for CO₂/CH₄ separation, demonstrating a successful combination of molecular sieving mechanism of AlPO-14 molecular sieve fillers with the solution-diffusion mechanism of the UV cross-linked poly(DSDA-TMMDA) polyimide matrix in this mixed matrix membrane for CO₂/CH₄ gas separation.

FIG. 13 shows CO₂/CH₄ separation performance of P2 polymer membrane and the UV cross-linked MMM 3 mixed matrix membrane at 50° C. and 690 kPa (100 psig), as well as Robeson's 1991 polymer upper limit data for CO₂/CH₄ separation at 35° C. and 345 kPa (50 psig) from literature (see Robeson, J. MEMBR. SCI., 62: 165 (1991)). It can be seen that the CO₂/CH₄ separation performance of P2 polymer membrane is far below Robeson's 1991 polymer upper bound for CO₂/CH₄ separation. The UV cross-linked MMM 3, however, showed significantly CO₂/CH₄ separation performance that almost reached Robeson's 1991 polymer upper bound for CO₂/CH₄ separation.

TABLE 3
Pure gas permeation test results of P2 and MMM 3 membranes for
CO₂/CH₄ separation^{a}

| | P_{CO2} | ΔP_{CO2} | | |
|---|---|---|---|---|
| Membrane | (Barrer) | (Barrer) | α_{CO2/CH4} | Δα_{CO2/CH4} |
| P2 | 18.5 | 0 | 24.8 | 0 |
| MMM 3 | 29.4 | 59% | 39.8 | 60% |

^{a}Tested at 50° C. under 690 kPa (100 psig) pure gas pressure;
1 Barrer = 10⁻¹⁰ (cm³(STP) · cm)/(cm² · sec · cmHg)

### Example 10

### Preparation of UV Cross-Linked 30% UZM-25/PES/Poly(DSDA-TMMDA) Mixed Matrix Membrane (Abbreviated as MMM 4)

A UV cross-linked polyethersulfone (PES) functionalized UZM-25/poly(DSDA-TMMDA) mixed matrix membrane (MMM 4) containing 30 wt-% of dispersed UZM-25 (pure silica form) molecular sieve fillers in a UV cross-linked poly(DSDA-TMMDA) polyimide continuous matrix was prepared as follows:

1.8 g of UZM-25 molecular sieves were dispersed in a mixture of NMP and 1,3-dioxolane by mechanical stirring and ultrasonication for 1 h to form a slurry. Then 0.6 g of PES was added to functionalize UZM-25 molecular sieves in the slurry. The slurry was stirred for at least 1 h to completely dissolve PES polymer and functionalize the surface of UZM-25. After that, 5.6 g of poly(DSDA-TMMDA) polyimide polymer was added to the slurry and the resulting mixture was stirred for another 3 h to form a stable casting dope containing 30 wt-% of dispersed PES functionalized UZM-25 molecular sieves (weight ratio of UZM-25 to poly(DSDA-TMMDA) and PES is 30:100; weight ratio of PES to poly(DSDA-TMMDA) is 1:9) in the continuous poly(DSDA-TMMDA) polymer matrix. The stable casting dope was allowed to degas overnight.

A 30% UZM-25/PES/poly(DSDA-TMMDA) mixed matrix membrane was prepared on a clean glass plate from the bubble free stable casting dope using a doctor knife with a 20-mil gap. The film together with the glass plate was then put into a vacuum oven. The solvents were removed by slowly increasing the vacuum and the temperature of the vacuum oven. Finally, the membrane was dried at 200° C. under vacuum for at least 48 h to completely remove the residual solvents to form 30% UZM-25/PES/poly(DSDA-TMMDA) mixed matrix membrane.

A MMM 4 membrane as described in Table 4 was prepared by further UV cross-linking the 30% UZM-25/PES/poly(DSDA-TMMDA) mixed matrix membrane by exposure to UV radiation using 254 nm wavelength UV light generated from a UV lamp with 1.9 cm (0.75 inch) distance from the membrane surface to the UV lamp and a radiation time of 10 min at 50° C. The UV lamp described here is a low pressure, mercury arc immersion UV quartz 12 watt lamp with 12 watt power supply from Ace Glass Incorporated.

### Example 11

### CO₂/CH₄ Separation Properties of P2 and MMM 4 Membranes

The permeabilities of CO₂ and CH₄ (P_{CO2} and P_{CH4}) and selectivity of CO₂/CH₄ (α_{CO2/CH4}) of P2 membrane prepared in Example 7 and MMM 4 mixed matrix membrane prepared in Example 10 were measured by pure gas measurements at 50° C. under about 690 kPa (100 psig) pressure. The results for CO₂/CH₄ separation are shown in Table 4.

It can be seen from Table 4 that the UV cross-linked MMM 4 mixed matrix membrane prepared in Example 10 containing 30 wt-% UZM-25 molecular sieve fillers in the UV cross-linked poly(DSDA-TMMDA) polymer matrix showed that α_{CO2/CH4} increased from about 25 of P2 polymer membrane to about 39 and α_{CO2/CH4} increased about 60% compared to P2 polymer membrane for CO₂/CH₄ separation, suggesting that UZM-25 is a suitable molecular sieve filler (micro pore size: 2.5×4.2 Å and 3.1×4.2 Å) with molecular sieving mechanism for the preparation of high selectivity molecular sieve/polymer mixed matrix membranes for CO₂/CH₄ gas separation.

TABLE 4
Pure gas permeation test results of P2 and MMM 4
membranes for CO₂/CH₄ separation^{a}

| | P_{CO2} | | |
|---|---|---|---|
| Membrane | (Barrer) | α_{CO2/CH4} | Δα_{CO2/CH4} |
| P2 | 18.5 | 24.8 | 0 |
| MMM 4 | 15.3 | 39.2 | 58% |

^{a}Tested at 50° C. under 690 kPa (100 psig) pure gas pressure;
1 Barrer = 10⁻¹⁰ (cm³(STP) · cm)/(cm² · sec · cmHg)

### Example 12

### Preparation of UV Cross-Linkable Poly(BTDA-PMDA-ODPA-TMMDA)-PES Polymer Membrane (Abbreviated as P3)

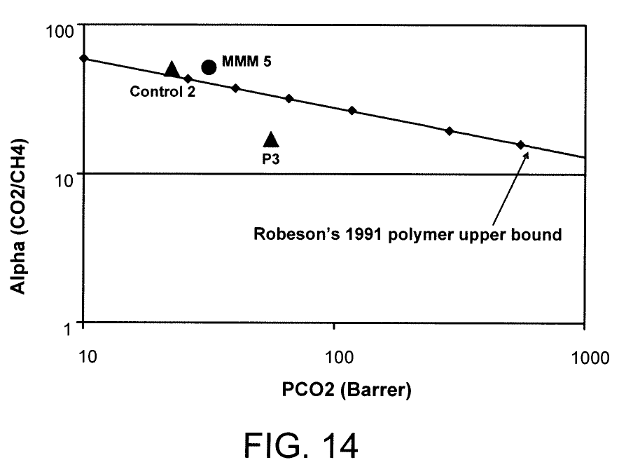

5.4 g of poly(BTDA-PMDA-ODPA-TMMDA) polyimide polymer (FIG. 7) and 0.6 g of polyethersulfone (PES) were dissolved in a solvent mixture of NMP and 1,3-dioxolane by mechanical stirring for 3 h to form a homogeneous casting dope. The resulting homogeneous casting dope was allowed to degas overnight. A P3 polymer membrane was prepared from the bubble free casting dope on a clean glass plate using a doctor knife with a 20-mil gap. The film together with the glass plate was then put into a vacuum oven. The solvents were removed by slowly increasing the vacuum and the temperature of the vacuum oven. Finally, the membrane was dried at 200° C. under vacuum for at least 48 h to completely remove the residual solvents to form P3 membrane as described in Table 5 and FIG. 14).

### Example 13

### Preparation of UV Cross-Linked Poly(BTDA-PMDA-ODPA-TMMDA) Polymer Membrane (Abbreviated as Control 2)

The Control 2 membrane was prepared by further UV cross-linking P3 polymer membrane by exposure to UV radiation using 254 nm wavelength UV light generated from a UV lamp with 1.9 cm (0.75 inch) distance from the membrane surface to the UV lamp and a radiation time of 10 min at 50° C. The UV lamp described here is a low pressure, mercury arc immersion UV quartz 12 watt lamp with 12 watt power supply from Ace Glass Incorporated.

### Example 14

### Preparation of UV Cross-Linked 30% AlPO-14/PES/Poly(BTDA-PMDA-ODPA-TMMDA) Mixed Matrix Membrane (Abbreviated as MMM 5)

UV cross-linked polyethersulfone (PES) functionalized AlPO-14/poly(BTDA-PMDA-ODPA-TMMDA) mixed matrix membrane (abbreviated as MMM 5) containing 30 wt-% of dispersed AlPO-14 molecular sieve fillers in UV cross-linked poly(BTDA-PMDA-ODPA-TMMDA) polyimide continuous matrix (UV cross-linked 30% AlPO-14/PES/poly(BTDA-PMDA-ODPA-TMMDA)) was prepared as follows:

1.8 g of AlPO-14 molecular sieves were dispersed in a mixture of NMP and 1,3-dioxolane by mechanical stirring and ultrasonication for 1 h to form a slurry. Then 0.6 g of PES was added to functionalize AlPO-14 molecular sieves in the slurry. The slurry was stirred for at least 1 h to completely dissolve PES polymer and functionalize the surface of AlPO-14. After that, 5.6 g of poly(BTDA-PMDA-ODPA-TMMDA) polyimide polymer was added to the slurry and the resulting mixture was stirred for another 2 h to form a stable casting dope containing 30 wt-% of dispersed PES functionalized AlPO-14 molecular sieves (weight ratio of AlPO-14 to poly(BTDA-PMDA-ODPA-TMMDA) and PES is 30:100; weight ratio of PES to poly(BTDA-PMDA-ODPA-TMMDA) is 1:9) in the continuous poly(BTDA-PMDA-ODPA-TMMDA) polymer matrix. The stable casting dope was allowed to degas overnight.

A 30% AlPO-14/PES/poly(BTDA-PMDA-ODPA-TMMDA) mixed matrix membrane was prepared on a clean glass plate from the bubble free stable casting dope using a doctor knife with a 20-mil gap. The film together with the glass plate was then put into a vacuum oven. The solvents were removed by slowly increasing the vacuum and the temperature of the vacuum oven. Finally, the membrane was dried at 200° C. under vacuum for at least 48 h to completely remove the residual solvents to form 30% AlPO-14/PES/poly(BTDA-PMDA-ODPA-TMMDA) mixed matrix membrane.

The MMM 5 mixed matrix membrane was prepared by further UV cross-linking the 30% AlPO-14/PES/poly(BTDA-PMDA-ODPA-TMMDA) mixed matrix membrane by exposure to UV radiation using 254 nm wavelength UV light generated from a UV lamp with 1.9 cm (0.75 inch) distance from the membrane surface to the UV lamp and a radiation time of 10 min at 50° C. The UV lamp described here is a low pressure, mercury arc immersion UV quartz 12 watt lamp with 12 watt power supply from Ace Glass Incorporated.

### Example 15

### CO₂/CH₄ Separation Properties of P3, Control 2, and MMM 5 Membranes

The permeabilities of CO₂ and CH₄ (P_{CO2} and P_{CH4}) and selectivity of CO₂/CH₄ (α_{CO2/CH4}) of P3 polymer membrane prepared in Example 12, Control 2 polymer membrane prepared in Example 13, and MMM 5 mixed matrix membrane prepared in Example 14 were measured by pure gas measurements at 50° C. under about 690 kPa (100 psig) pressure. The results for CO₂/CH₄ separation are shown in Table 5 and FIG. 14.

It can be seen from Table 5 and FIG. 14 that Control 2 polymer membrane showed 199% increase in α_{CO2/CH4}, but P_{CO2} decreased by 60% compared P3 polymer membrane. The α_{CO2/CH4} of MMM 5 mixed matrix membrane prepared in Example 14 increased to 51 and improved 201% with 43% decrease in P_{CO2} compared to that of the P3 polymer membrane.

FIG. 14 shows CO₂/CH₄ separation performance of P3, Control 2, and MMM 5 at 50° C. and 690 kPa (100 psig), as well as Robeson's 1991 polymer upper limit data for CO₂/CH₄ separation at 35° C. and 345 kPa (50 psig) from literature (see Robeson, J. Membr. Sci., 62: 165 (1991)). It can be seen that the CO₂/CH₄ separation performances of P3 polymer membrane is far below Robeson's 1991 polymer upper bound for CO₂/CH₄ separation. The Control 2 polymer membrane showed improved CO₂/CH₄ separation performance and reached Robeson's 1991 polymer upper bound for CO₂/CH₄ separation. The MMM 5 mixed matrix membrane showed CO₂/CH₄ separation performance that exceeded Robeson's 1991 polymer upper bound for CO₂/CH₄ separation. These results indicate that the novel voids and defects free MMM 5 mixed matrix membrane is a good membrane candidate for the removal of CO₂ from natural gas or flue gas. The improved performance of MMM 5 mixed matrix membrane over P3 polymer membrane and Control 2 polymer membrane is attributed to the successful combination of molecular sieving mechanism of AlPO-14 molecular sieve fillers with the solution-diffusion mechanism of the UV cross-linked poly(BTDA-PMDA-ODPA-TMMDA) polyimide matrix.

TABLE 5
Pure gas permeation test results of P3, Control 2, and MMM 5
membranes for CO₂/CH₄ separation^{a}

| | P_{CO2} | ΔP_{CO2} | | |
|---|---|---|---|---|
| Membrane | (Barrer) | (Barrer) | α_{CO2/CH4} | Δα_{CO2/CH4} |
| P3 | 55.5 | 0 | 17.0 | 0 |
| Control 2 | 22.4 | −60% | 50.9 | 199% |
| MMM 5 | 31.6 | −43% | 51.1 | 201% |

^{a}Tested at 50° C. under 690 kPa (100 psig) pure gas pressure;
1 Barrer = 10⁻¹⁰ (cm³(STP) · cm)/(cm² · sec · cmHg)

1. A method of making UV cross-linked polymer functionalized molecular sieve/polymer mixed matrix membrane comprising:
a) dispersing a quantity of molecular sieve particles having an exterior surface in a mixture of two or more organic solvents to form a molecular sieve slurry;
b) dissolving a suitable polymer in the molecular sieve slurry to functionalize the exterior surface of the molecular sieve particles;
c) dissolving a UV cross-linkable polymer that serves as a continuous polymer matrix in the polymer functionalized molecular sieve slurry to form a stable polymer functionalized molecular sieve/polymer suspension;
d) fabricating a UV cross-linkable mixed matrix membrane using the stable polymer functionalized molecular sieve/polymer suspension; and
e) cross-linking the UV cross-linkable mixed matrix membrane.

2. The method of claim 1 further comprising fabricating a mixed matrix membrane in a form of a symmetric dense film, a thin-film composite, an asymmetric flat sheet, or an asymmetric hollow fiber membrane using said polymer functionalized molecular sieve/polymer suspension.

3. The method of claim 1 wherein said molecular sieve particles are selected from the group consisting of microporous and mesoporous molecular sieves, carbon molecular sieves, and porous metal-organic frameworks (MOFs).

4. The method of claim 3 wherein said molecular sieves are zeolites based on an aluminosilicate composition or non-zeolites based on aluminophosphates, silico-aluminophosphates, or silica.

5. The method of claim 3 wherein said molecular sieves are selected from the group consisting of silicalite-1, SAPO-34, Si-DDR, AlPO-14, AlPO-34, AlPO-18, SSZ-62, UZM-5, UZM-25, UZM-12, UZM-9, AlPO-17, SSZ-13, SSZ-16, ERS-12, CDS-1, MCM-65, MCM-47, 4A, 5A, SAPO-44, SAPO-47, SAPO-17, CVX-7, SAPO-35, SAPO-56, AlPO-52, SAPO-43, IRMOF-1, Cu₃(BTC)₂ MOF, and mixtures thereof.

6. The method of claim 1 wherein said UV cross-linkable polymers contain functional groups selected from the group consisting of nitrile, benzophenone, acrylic, vinyl, styrenic, styrenic-acrylic, aryl sulfonyl, 3,4-epoxycyclohexyl, 2,3-dihydrofuran, and mixtures thereof.

7. The method of claim 1 wherein said UV cross-linkable polymer that serves as a continuous polymer matrix is selected from the group consisting of polysulfones, sulfonated polysulfones, polyethersulfones (PESs), sulfonated PESs, polyacrylates, polyetherimides, poly(styrenes), polyimides, polyamide/imides, polyketones, polyether ketones, and mixtures thereof.

8. The method of claim 1 wherein said UV cross-linkable polymer that serves as a continuous polymer matrix is selected from the group consisting of polysulfones, polyethersulfones (PESs), sulfonated PESs, Matrimid sold under the trademark Matrimid® by Huntsman Advanced Materials, P84 or P84HT sold under the tradename P84 and P84HT respectively from HP Polymers GmbH; poly(3,3′,4,4′-benzophenone tetracarboxylic dianhydride-pyromellitic dianhydride-4,4′-oxydiphthalic anhydride-3,3′,5,5′-tetramethyl-4,4′-methylene dianiline) (poly(BTDA-PMDA-ODPA-TMMDA)), poly(3,3′,4,4′-diphenylsulfone tetracarboxylic dianhydride-3,3′,5,5′-tetramethyl-4,4′-methylene dianiline) (poly(DSDA-TMMDA)), poly(3,3′,4,4′-diphenylsulfone tetracarboxylic dianhydride-pyromellitic dianhydride-3,3′,5,5′-tetramethyl-4,4′-methylene dianiline) (poly(DSDA-PMDA-TMMDA)), UV cross-linkable microporous polymers, and mixtures thereof.

9. The method of claim 1 wherein said suitable polymer used to functionalize the exterior surface of the molecular sieve particles contains functional groups selected from the group consisting of hydroxyl, amino, isocyanato, carboxylic acid, ether containing polymers and mixtures thereof.

10. The method of claim 7 wherein said suitable polymer used to functionalize the exterior surface of the molecular sieve particles comprises polyethersulfones, poly(hydroxyl styrene), sulfonated polyethersulfones, hydroxyl group-terminated poly(ethylene oxide)s, amino group-terminated poly(ethylene oxide)s, isocyanate group-terminated poly(ethylene oxide)s, hydroxyl group-terminated poly(propylene oxide)s, hydroxyl group-terminated co-block-poly(ethylene oxide)-poly(propylene oxide)s, hydroxyl group-terminated tri-block-poly(propylene oxide)-block-poly(ethylene oxide)-block-poly(propylene oxide)s, tri-block-poly(propylene glycol)-block-poly(ethylene glycol)-block-poly(propylene glycol) bis(2-aminopropyl ether), poly(aryl ether ketone)s, poly(ethylene imine)s, poly(amidoamine)s, poly(vinyl alcohol)s, poly(vinyl acetate)s, poly(allyl amine)s, poly(vinyl amine)s, polyetherimides, cellulose acetate, cellulose triacetate, cellulose acetate-butyrate, cellulose propionate, ethyl cellulose, methyl cellulose, nitrocellulose, and mixtures thereof.

11. The method of claim 9 wherein said suitable polymer used to functionalize the exterior surface of the molecular sieve particles comprises polyethersulfone, poly(hydroxyl styrene), poly(ethylene imine), poly(amidoamine), poly(vinyl alcohol), poly(vinyl acetate), poly(allyl amine), poly(vinyl amine), polyetherimide, cellulose triacetate, and mixtures thereof.

12. The method of claim 1 wherein the ratio of said molecular sieves to said polymer to functionalize the exterior surface of the molecular sieve particles is between 5 parts molecular sieve by weight to 100 parts polymer by weight and 100 parts molecular sieves by weight to 1 part polymer by weight.

13. The method of claim 1 wherein the ratio of said molecular sieves to said UV cross-linkable polymer that serves as a continuous polymer matrix is between 5 parts molecular sieve by weight to 100 parts polymer by weight and 100 parts molecular sieves by weight to 50 parts polymer by weight.

14. The method of claim 1 wherein said solvent is selected from the group consisting of N-methylpyrrolidone, N,N-dimethyl acetamide, methylene chloride, THF, acetone, DMF, DMSO, toluene, dioxanes, 1,3-dioxolane, acetone, isopropanol, methanol, octane, and mixtures thereof.

15. The method of claim 1 further comprising coating said mixed matrix membrane with a thin layer of a material selected from the group consisting of a polysiloxane, a fluoropolymer and a thermally curable silicon rubber.

16. The method of claim 1 further comprising coating the UV cross-linkable mixed matrix membrane with a layer of UV radiation curable epoxy silicon material followed by exposing said UV radiation curable epoxy silicon material to UV radiation for a period of time sufficient to crosslink said curable epoxy silicon material.

17. The method of claim 1 wherein said UV crosslinked polymer functionalized molecular sieve/polymer mixed matrix membrane is characterized as having voids between said UV crosslinked polymer and said molecular sieves that are no larger than 5 angstroms (0.5 nm).

18. A process for separating at least one component in gas, vapor, or liquid phase from a mixture of components in gas, vapor, or liquid phase, said process comprising (a) providing a UV cross-linked mixed matrix membrane comprising a polymer functionalized molecular sieve particles uniformly dispersed in a continuous UV cross-linked polymer matrix which is permeable to said at least one component in gas, vapor, or liquid phase; (b) contacting the mixture of components on one side of the UV cross-linked mixed matrix membrane to cause said at least one component to permeate the UV cross-linked mixed matrix membrane; and (c) removing from the opposite side of the membrane a permeate gas, vapor, or liquid composition comprising said at least one component which permeated said membrane.

19. The process of claim 18 wherein said UV cross-linked mixed matrix membrane is in a form of a symmetric dense film, an asymmetric thin film composite, an asymmetric flat sheet, or an asymmetric hollow fiber membrane.

20. The process of claim 18 wherein said molecular sieve particles are selected from the group consisting of microporous and mesoporous molecular sieves, carbon molecular sieves, and porous metal-organic frameworks (MOFs).

21. The process of claim 18 wherein said molecular sieve particles are zeolites based on an aluminosilicate composition or non-zeolites based on aluminophosphates, silico-aluminophosphates, or silica.

22. The process of claim 18 wherein said UV cross-linked mixed matrix membrane is made from UV cross-linkable polymers containing functional groups selected from the group consisting of nitrile, benzophenone, acrylic, vinyl, styrenic, styrenic-acrylic, aryl sulfonyl, 3,4-epoxycyclohexyl, 2,3-dihydrofuran, and mixtures thereof.

23. The process of claim 18 wherein said UV cross-linked mixed matrix membrane is made from UV cross-linkable polymers selected from the group consisting of polysulfones, sulfonated polysulfones, polyethersulfones (PESs), sulfonated PESs, polyacrylates, polyetherimides, poly(styrenes), polyimides, polyamide/imides, polyketones, polyether ketones, and mixtures thereof.

24. The process of claim 18 wherein said UV cross-linked mixed matrix membrane is made from UV cross-linkable polymers selected from the group consisting of polysulfones, polyethersulfones (PESs), sulfonated PESs, Matrimid sold under the trademark Matrimid® by Huntsman Advanced Materials, P84 or P84HT sold under the tradename P84 and P84HT respectively from HP Polymers GmbH; poly(3,3′,4,4′-benzophenone tetracarboxylic dianhydride-pyromellitic dianhydride-4,4′-oxydiphthalic anhydride-3,3′,5,5′-tetramethyl-4,4′-methylene dianiline) (poly(BTDA-PMDA-ODPA-TMMDA)), poly(3,3′,4,4′-diphenylsulfone tetracarboxylic dianhydride-3,3′,5,5′-tetramethyl-4,4′-methylene dianiline) (poly(DSDA-TMMDA)), poly(3,3′,4,4′-diphenylsulfone tetracarboxylic dianhydride-pyromellitic dianhydride-3,3′,5,5′-tetramethyl-4,4′-methylene dianiline) (poly(DSDA-PMDA-TMMDA)), UV cross-linkable microporous polymers, and mixtures thereof.

25. The process of claim 18 wherein said suitable polymer used to functionalize the molecular sieve particles contains functional groups selected from the group consisting of hydroxyl, amino, isocyanato, carboxylic acid, ether containing polymers and mixtures thereof.

26. The process of claim 18 wherein said polymer functionalized molecular sieve particles comprises at least one polymer selected from the group comprising polyethersulfones, poly(hydroxyl styrene), sulfonated polyethersulfones, hydroxyl group-terminated poly(ethylene oxide)s, amino group-terminated poly(ethylene oxide)s, isocyanate group-terminated poly(ethylene oxide)s, hydroxyl group-terminated poly(propylene oxide)s, hydroxyl group-terminated co-block-poly(ethylene oxide)-poly(propylene oxide)s, hydroxyl group-terminated tri-block-poly(propylene oxide)-block-poly(ethylene oxide)-block-poly(propylene oxide)s, tri-block-poly(propylene glycol)-block-poly(ethylene glycol)-block-poly(propylene glycol) bis(2-aminopropyl ether), poly(aryl ether ketone)s, poly(ethylene imine)s, poly(amidoamine)s, poly(vinyl alcohol)s, poly(vinyl acetate)s, poly(allyl amine)s, poly(vinyl amine)s, polyetherimides, cellulose acetate, cellulose triacetate, cellulose acetate-butyrate, cellulose propionate, ethyl cellulose, methyl cellulose, and nitrocellulose.

27. The process of claim 18 wherein said mixed matrix membrane is coated with a thin layer of a material selected from the group consisting of a polysiloxane, a fluoropolymer and a thermally curable silicon rubber.

28. The process of claim 18 wherein said UV cross-linkable mixed matrix membrane is coated with a layer of UV radiation cured epoxy silicon material.

29. The process of claim 18 wherein said UV crosslinked polymer functionalized molecular sieve/polymer membrane is characterized as having voids between said UV crosslinked polymer and said molecular sieves that are no larger than 5 angstroms (0.5 nm).

30. The process of claim 18 wherein said mixture of components is selected from at least one pair of gases wherein said pairs of gases comprise carbon dioxide/methane, hydrogen/methane, oxygen/nitrogen, water vapor/methane and carbon dioxide/nitrogen.

31. The process of claim 18 wherein said mixture of components comprises sulfur-containing hydrocarbon streams including sulfur-containing naphtha streams.

32. A composition comprising a UV cross-linked polymer functionalized molecular sieve/polymer membrane comprising a molecular sieve, a polymer connected to said molecular sieve, and a continuous phase polymer.

33. The composition of claim 32 wherein said molecular sieve particles are selected from the group consisting of microporous and mesoporous molecular sieves, carbon molecular sieves, and porous metal-organic frameworks (MOFs).

34. The composition of claim 33 wherein said molecular sieves are zeolites based on an aluminosilicate composition or non-zeolites based on aluminophosphates, silico-aluminophosphates, or silica.

35. The composition of claim 33 wherein said microporous molecular sieves are selected from the group consisting of SAPO-34, Si-DDR, UZM-9, AlPO-14, AlPO-34, AlPO-17, SSZ-62, SSZ-13, AlPO-18, LTA, ERS-12, CDS-1, MCM-65, MCM-47, 4A, 5A, UZM-5, UZM-25, UZM-12, silicalite-1, SSZ-16, AlPO-34, SAPO-44, SAPO-47, SAPO-17, CVX-7, SAPO-35, SAPO-56, AlPO-52, SAPO-43, zeolite L, NaX, NaY, and CaY.

36. The composition of claim 33 wherein said microporous molecular sieves are selected from the group consisting of AlPO-18, AlPO-14, AlPO-17, UZM-5, UZM-25, ERS-12, CDS-1, MCM-65, CVX-7, SAPO-34, SAPO-56, and mixtures thereof.

37. The composition of claim 33 wherein said mesoporous molecular sieves are selected from the group consisting of MCM-41, SBA-15, and surface functionalized MCM-41 and SBA-15.

38. The composition of claim 33 wherein said porous metal-organic frameworks are selected from the group consisting of IRMOF-1, Cu₃(BTC)₂ MOF, and mixtures thereof.

39. The composition of claim 32 wherein said molecular sieves are sub-micron size molecular sieves with particle sizes in the range of 5 to 1000 nm.

40. The composition of claim 39 wherein said sub-micron size molecular sieves are selected from the group consisting of SAPO-34, Si-DDR, UZM-9, AlPO-14, AlPO-34, AlPO-17, SSZ-62, SSZ-13, AlPO-18, LTA, ERS-12, CDS-1, MCM-65, MCM-47, 4A, 5A, UZM-5, UZM-25, UZM-12, silicalite-1, SSZ-16, AlPO-34, SAPO-44, SAPO-47, SAPO-17, CVX-7, SAPO-35, SAPO-56, AlPO-52, SAPO-43, IRMOF-1, Cu₃(BTC)₂ MOF, and mixtures thereof.

41. The composition of claim 32 wherein there is a covalent or hydrogen bond between said molecular sieve and said polymer connected to said molecular sieve.

42. The composition of claim 32 wherein said polymer connected to said molecular sieve is selected from the group consisting of polyethersulfones, poly(hydroxyl styrene), sulfonated polyethersulfones, hydroxyl group-terminated poly(ethylene oxide)s, amino group-terminated poly(ethylene oxide)s, isocyanate group-terminated poly(ethylene oxide)s, hydroxyl group-terminated poly(propylene oxide)s, hydroxyl group-terminated co-block-poly(ethylene oxide)-poly(propylene oxide)s, hydroxyl group-terminated tri-block-poly(propylene oxide)-block-poly(ethylene oxide)-block-poly(propylene oxide)s, tri-block-poly(propylene glycol)-block-poly(ethylene glycol)-block-poly(propylene glycol) bis(2-aminopropyl ether), polyether ketones, poly(ethylene imine)s, poly(amidoamine)s, poly(vinyl alcohol)s, poly(vinyl acetate)s, poly(allyl amine)s, poly(vinyl amine)s, polyetherimides, cellulose acetate, cellulose triacetate, cellulose acetate-butyrate, cellulose propionate, ethyl cellulose, methyl cellulose, and nitrocellulose.

43. The composition of claim 32 wherein said continuous phase polymers are selected from the group consisting of polysulfones; polyethersulfones (PESs), sulfonated PESs; Matrimid sold under the trademark Matrimid® by Huntsman Advanced Materials, P84 or P84HT sold under the tradename P84 and P84HT respectively from HP Polymers GmbH, poly(3,3′,4,4′-benzophenone tetracarboxylic dianhydride-pyromellitic dianhydride-4,4′-oxydiphthalic anhydride-3,3′,5,5′-tetramethyl-4,4′-methylene dianiline) (poly(BTDA-PMDA-ODPA-TMMDA)), poly(3,3′,4,4′-diphenylsulfone tetracarboxylic dianhydride-3,3′,5,5′-tetramethyl-4,4′-methylene dianiline) (poly(DSDA-TMMDA)), poly(3,3′,4,4′-diphenylsulfone tetracarboxylic dianhydride-pyromellitic dianhydride-3,3′,5,5′-tetramethyl-4,4′-methylene dianiline) (poly(DSDA-PMDA-TMMDA)), UV cross-linkable microporous polymers, and mixtures thereof.

44. The composition of claim 32 wherein said continuous phase polymers contain UV cross-linkable groups selected from the group consisting of nitrile, benzophenone, acrylic, vinyl, styrenic), styrenic-acrylic, aryl sulfonyl, 3,4-epoxycyclohexyl, and 2,3-dihydrofuran groups or mixtures of these groups.

45. The composition of claim 32 wherein said UV cross-linked polymer functionalized molecular sieve/polymer membrane is used to separate organic compounds from water.

46. The composition of claim 45 wherein said organic compounds are selected from the group consisting of alcohol, phenols, chlorinated hydrocarbons, pyridines, ketones and mixtures thereof.

47. The composition of claim 32 wherein said UV cross-linked polymer functionalized molecular sieve/polymer membrane is used to separate isomers of organic compounds.

48. The composition of claim 32 wherein said UV cross-linked polymer functionalized molecular sieve/polymer membrane is used to separate organic compounds selected from the group of pairs of compounds consisting of sulfur-containing hydrocarbons-hydrocarbons, ethylacetate-ethanol, diethylether-ethanol, acetic acid-ethanol, benzene-ethanol, chloroform-ethanol, chloroform-methanol, acetone-isopropylether, allylalcohol-allylether, allylalcohol-cyclohexane, butanol-butylacetate, butanol-1-butylether, ethanol-ethylbutylether, propylacetate-propanol, isopropylether-isopropanol, methanol-ethanol-isopropanol, and ethylacetate-ethanol-acetic acid.
